(19) United States
(12) Patent Application Publication
(10) Pub. No.: US 2015/0035388 A1
(43) Pub. Date: Feb. 5, 2015

(54) Linear Motor

(71) Applicant: Hitachi Metals, Ltd., Tokyo (JP)

(72) Inventors: Masahiro Mita, Takasaki (JP); Masahiro Masuzawa, Takasaki (JP); Makoto Kawakami, Mishima-gun (JP)

(21) Appl. No.: 14/378,007

(22) PCT Filed: Feb. 12, 2013
(86) PCT No.: PCT/JP2013/053200

§ 371 Date: Aug. 11, 2014

(30) Foreign Application Priority Data
Feb. 16, 2012 (JP) 2012-032075
Nov. 19, 2012 (JP) 2012-253517

(51) Int. Cl. H02K 41/03

(52) U.S. Cl. CPC H02K 41/033
USPC 310/12.18

(57) ABSTRACT

An object is to provide a linear motor in which even when the moving range of a movable element is long, the quantity of magnets to be employed is not increased.

A linear motor comprising; a movable element is in a plurality of magnets and armature cores linked alternately along a moving direction are arranged in the inside of a coil and then adjacent magnets with an armature core in between are magnetized in opposite directions; the stator includes two opposite plate-shaped parts elongated in the moving direction of the movable element and linked magnetically; in each of opposite faces of the two plate-shaped parts, tooth parts composed of magnetic material having a substantially rectangular parallelepiped shape similar to a bar shape are arranged at given intervals; and the movable element moves along an arrangement direction of the tooth parts between the two opposite plate-shaped parts.

### CROSS-REFERENCE TO RELATED APPLICATIONS

This application is the national phase under 35 U.S.C. §371 of PCT International Application No. PCT/JP2013/053200 which has an International filing date of Feb. 12, 2013 and designated the United States of America.

### TECHNICAL FIELD

The present invention relates to a linear motor constructed by combining a stator and a movable element provided with a drive coil.

### BACKGROUND ART

For example, in a semiconductor manufacturing device and in the field of manufacturing of a liquid crystal display, a feed device is employed that can be moved linearly a processing object such as a substrate of large area at high speeds and then can be positioned precisely the processing object at appropriate position. In general, a feed device of this type is implemented by converting into linear motion the rotational motion of a motor serving as a driving source, by using a motion conversion mechanism such as a ball screw mechanism. However, interposition of the motion conversion mechanism causes a limitation in improvement of the movement speed. Further, the presence of a mechanical error in the motion conversion mechanism causes also a problem of insufficient positioning accuracy.

For the purpose of resolving this problem, in recent years, a feed device is adopted that employs as a driving source a linear motor which can take out a linear motion output directly. The linear motor includes a stator of linear shape and a movable element moving along the stator. In the feed device described above, a linear motor of moving coil type is employed in which a stator is constructed by aligning a large number of plate-shaped permanent magnets at constant intervals and an armature provided with magnetic pole teeth and an energization coil is employed as a movable element (for example, see Japanese Patent Application Laid-Open No. 03-139160).

### BRIEF SUMMARY OF THE INVENTION

### Problems to be Solved

In the linear motor of moving coil type, magnets are arranged in the stator. Thus, the quantity of magnets to be employed increases with increasing overall length of the linear motor (with increasing moving distance of the movable element). In association with the recent price rise in rare earths, the increase in the quantity of magnets to be employed has caused a cost increase.

Further, since the magnets are arranged in the stator yoke fabricated from magnetic material, the thickness of the stator is equal to the thickness of which is connected the stator yoke and the magnet. This has caused difficulty in size reduction of the linear motor.

Further, the work of arranging the magnets in the stator yoke is complicated and hence has caused a cost increase.

The present invention has been devised in view of the above-mentioned situations. An object thereof is to provide a linear motor in which even when the overall length of the linear motor is long, the quantity of magnets to be employed is not increased. Further, another object is to provide a linear motor in which thickness reduction is allowed in the stator and fabrication of the stator is easy.

### Means to Solving the Problem

The linear motor according to the present invention is characterized by a linear motor comprising a stator composed of magnetic material and a movable element, wherein: in the movable element, a plurality of magnets and armature cores linked alternately along a moving direction are arranged in the inside of a coil and then adjacent magnets with an armature core in between are magnetized in opposite directions; the stator includes two mutually opposite plate-shaped parts elongated in the moving direction of the movable element and linked magnetically; in each of opposite faces of the two plate-shaped parts, tooth parts composed of magnetic material having a substantially rectangular parallelepiped shape similar to a bar shape are arranged at given intervals; and the movable element moves along an arrangement direction of the tooth parts between the two mutually opposite plate-shaped parts.

In the present invention, in the movable element, a plurality of magnets and armature cores linked alternately along the moving direction of the movable element are arranged in the inside of the coil. The magnets are employed only in the movable element. Thus, even when the overall linear motor length is increased, the quantity of magnets to be employed is not increased and is fixed. This permits cost reduction.

The linear motor according to the present invention is characterized in that the tooth parts arranged on one face of the two plate-shaped parts and the tooth parts arranged on the other face of the two plate-shaped parts are arranged alternately along the moving direction of the movable element.

The linear motor according to the present invention is characterized in that a longitudinal direction of the tooth parts is arranged substantially at right angles to the moving direction of the movable element.

The linear motor according to the present invention is characterized in that the magnet and the armature core have a substantially rectangular parallelepiped shape similar to a bar shape and respective faces along a longitudinal direction are connected in close contact with each other almost over the entire surfaces.

The linear motor according to the present invention is characterized in that both ends in the longitudinal direction of each of the magnets and of each of the armature cores have different positions in the moving direction of the movable element.

In the present invention, the magnet and the armature core are inclined so that the detent force is reduced and hence the thrust force non-uniformity caused by a difference in the relative positions of the stator and the movable element is allowed to be reduced.

The linear motor according to the present invention is characterized in that each of the magnets and each of the armature cores have individually one cross section of a parallelogram shape.

The linear motor according to the present invention is characterized in that the longitudinal direction of the tooth parts is inclined to a direction perpendicular to the moving direction of the movable element.

In the present invention, the tooth part provided in the stator is inclined with respect to the moving direction of the movable element so that the detent force is reduced and hence the thrust force non-uniformity caused by a difference in the relative positions of the stator and the movable element is allowed to be reduced.

The linear motor according to the present invention is characterized in that the tooth parts arranged on one face of the two plate-shaped parts and the tooth parts arranged on the other face of the two plated-shaped parts are inclined in different directions.

In the present invention, the tooth part provided on one face of the two plate-shaped parts and the tooth part provided on the other face of the two plate-shaped parts have inclinations in mutually different directions. This permits suppression of twist generated when the movable element is inclined to right and left with respect to the moving direction.

The linear motor according to the present invention is characterized by including armature cores having different lengths in the moving direction of the movable element.

In the present invention, the armature cores having mutually different lengths in the moving direction of the movable element are included so that the detent force is allowed to be reduced.

The linear motor according to the present invention is characterized in that the tooth parts are joined to the stator.

The linear motor according to the present invention is characterized in that the tooth parts are constructed from recesses and protrusions formed at the stator by a digging process.

In the present invention, the tooth part is formed by a digging process so that cost reduction is allowed in comparison with a case that the tooth part is joined.

The linear motor according to the present invention is characterized by a linear motor comprising a stator and a movable element, wherein: in the movable element, a plurality of magnets (also referred to as permanent magnets, hereinafter) and armature cores linked alternately along a moving direction are arranged inside a coil and then adjacent magnets with the armature core in between are magnetized in opposite directions; in the stator two mutually opposite plate-shaped parts elongated in the moving direction of the movable element and linked magnetically are included; the movable element is arranged between the two plate-shaped parts; and a plurality of magnetic material parts not protruding beyond the plate-shaped parts are aligned side by side along the moving direction in each of the plate-shaped parts.

In the present invention, in the movable element, the plurality of magnets and armature cores linked alternately along the moving direction of the movable element are arranged in the inside of the coil. The magnets are employed only in the movable element. Thus, even when the overall linear motor length is increased, the quantity of magnets to be employed is not increased and is constant. This permits cost reduction. In the plate-shaped part constituting the stator, since the plurality of magnetic material parts not protruding beyond the plate-shaped part are aligned, thickness reduction in the stator is achievable.

The linear motor according to the present invention is characterized in that the plurality of magnetic material parts are aligned side by side with a gap in between at equal intervals.

In the present invention, the plurality of magnetic material parts are aligned side by side with a gap in between at equal intervals. Thus, a tooth part in which the thickness of the plate-shaped part of the stator has variation like in the conventional art need not be formed and hence the stator is allowed to be made thin.

The linear motor according to the present invention is characterized in that the gap is a through hole having a rectangular parallelepiped shape and penetrating the plate-shaped part.

In the present invention, machining is performed such that a portion corresponding to the gap is removed from the plate-shaped part so that penetration is fabricated. Thus, the stator is allowed to be made thin.

The linear motor according to the present invention is characterized in that the magnetic material part is formed in a comb-tooth shape.

In the present invention, the magnetic material part is formed in a comb-tooth shape. Thus, the stator is allowed to be made thin and weight reduction is allowed.

The linear motor according to the present invention is characterized in that one magnetic material part and the other magnetic material part of the two plate-shaped parts are alternately arranged, at least in part, thereof is formed alternate along the moving direction of the movable element.

In the present invention, one magnetic material part and the other magnetic material part of the two plate-shaped parts are alternately arranged. This permits enhancement of the generated thrust force of the linear motor.

The linear motor according to the present invention is characterized in that a boundary surface between the magnetic material part and the gap is formed to be a planar surface and a surface normal vector with respect to the planer surface is formed to be parallel to a vector indicating the moving direction.

In the present invention, the surface normal vector of the plane is made parallel to the vector of the moving direction. This permits enhancement of the generated thrust force of the linear motor.

The linear motor according to the present invention is characterized in that a boundary surface between the magnetic material part and the gap is formed to be a planar surface and a plane including a surface normal vector with respect to the planar surface and a vector indicating the moving direction is parallel to the plate-shaped part; and the surface normal vector and the vector indicating the moving direction are non-parallel to each other.

In the present invention, the plane containing the surface normal vector of the boundary surface between the magnetic material part and the gap and the vector indicating the moving direction is parallel to the plate-shaped part, while the surface normal vector and the vector indicating the moving direction are non-parallel to each other. That is, the magnetic material part is inclined with respect to the moving direction of the stator so that the detent force is reduced and hence thrust force non-uniformity caused by a difference in the relative positions of the stator and the movable element is allowed to be reduced.

The linear motor according to the present invention is characterized in that a value obtained by adding an angle formed between a surface normal vector of one of the two plate-shaped parts and the vector indicating the moving direction to an angle formed between a surface normal vector of the other one of the two plate-shaped parts and the vector indicating the moving direction is equal to a value of an angle formed between the surface normal vector of the one of the two plate-shaped parts and the surface normal vector of the other one of the two plate-shaped parts.

In the present invention, a value obtained by adding an angle formed between a surface normal vector of one of the two plate-shaped parts and the vector indicating the moving direction to an angle formed between a surface normal vector of the other one of the two plate-shaped parts and the vector indicating the moving direction is equal to a value of an angle formed between the surface normal vector of the one of the two plate-shaped parts and the surface normal vector of the other one of the two plate-shaped parts. That is, the magnetic material part provided in one of the two plate-shaped parts and the magnetic material part provided in the other one have inclinations in different directions with respect to the moving direction. This permits suppression of twist generated when the movable element is inclined to right and left with respect to the moving direction.

The linear motor according to the present invention is characterized in that the magnet and the armature core have a rectangular parallelepiped shape and respective faces along a longitudinal direction are connected in close contact with each other almost over the entire surfaces.

In the present invention, the magnet and the armature core have a rectangular parallelepiped shape. This permits easy fabrication of the armature core. Further, since the magnet and the armature core are in close contact with each other, the permeance coefficient of the magnet is increased. In association with this, the magnetic flux amount generated per unit volume of the magnet is increased. This improves the utilization efficiency of the magnet.

The linear motor according to the present invention is characterized in that faces along the longitudinal direction of the magnet and the armature core are facing the moving direction of the movable element and both ends of the faces along the longitudinal direction have different positions in the moving direction such as to be inclined with respect to the moving direction.

In the present invention, both ends of the faces along the longitudinal direction of the magnet and the armature core have mutually different positions in the moving direction of the movable element. Thus, the detent force is reduced and hence thrust force non-uniformity caused by a difference in the relative positions of the stator and the movable element is allowed to be reduced.

The linear motor according to the present invention is characterized in that armature cores having different lengths in the moving direction of the movable element.

In the present invention, the armature cores having mutually different lengths in the moving direction of the movable element are included so that the detent force is allowed to be reduced.

The linear motor according to the present invention is characterized in that the gap is formed by cutting.

In the present invention, a portion corresponding to the gap is removed from the plate-shaped part so that the magnetic material part is formed. Thus, the stator is allowed to be made thin.

The linear motor according to the present invention is characterized in that the gap is formed by a punching process.

In the present invention, punching is performed on a portion corresponding to the gap in the plate-shaped part so that the magnetic material part is formed. This permits reduction in the processing cost.

### Effect of the Invention

In the present invention, an armature core arranged in a movable element is allowed to be reduced so that weight reduction and size reduction are allowed in the movable element. Further, magnets are employed only in the movable element. Thus, even when the overall linear motor length is increased, the quantity of magnets to be employed need not be increased and hence cost reduction is allowed. Furthermore, a plurality of magnetic material parts not protruding beyond a plate-shaped part of the stator are aligned so that thickness reduction and weight reduction are allowed in the stator.

### BRIEF DESCRIPTION OF THE DRAWINGS

FIG. 1 is a partly broken perspective view illustrating a schematic configuration of a linear motor according to Embodiment 1.

FIG. 2 is a plan view illustrating a movable element of a linear motor according to Embodiment 1.

FIG. 3 is a sectional view illustrating a schematic configuration of a linear motor according to Embodiment 1.

FIG. 4 is a side view illustrating a schematic configuration of a linear motor according to Embodiment 1.

FIG. 5 is a diagram for describing the principles of thrust force generation of a linear motor according to Embodiment 1.

FIG. 6 is a diagram for describing the principles of thrust force generation of a linear motor according to Embodiment 1.

FIG. 7 is a diagram for describing the principles of thrust force generation of a linear motor according to Embodiment 1.

FIG. 8 is a plan view illustrating a movable element of a linear motor according to Embodiment 2.

FIG. 9 is a sectional view illustrating a configuration of a stator of a linear motor according to Embodiment 3.

FIG. 10 is a sectional view illustrating a configuration of a stator of a linear motor according to Embodiment 4.

FIG. 11 is a partly broken perspective view illustrating a schematic configuration of a linear motor according to Embodiment 5.

FIG. 12 is a partly broken perspective view illustrating a stator of a linear motor according to Embodiment 5.

FIG. 13 is a sectional view illustrating a configuration of a stator of a linear motor according to Embodiment 5.

FIG. 14 is a sectional view illustrating a schematic configuration of a linear motor according to Embodiment 5.

FIG. 15 is a side view illustrating a schematic configuration of a linear motor according to Embodiment 5.

FIG. 16 is a diagram for describing the principles of thrust force generation of a linear motor according to Embodiment 5.

FIG. 17 is a diagram for describing the principles of thrust force generation of a linear motor according to Embodiment 5.

FIG. 18 is a diagram for describing the principles of thrust force generation of a linear motor according to Embodiment 5.

FIG. 19 is a plan view illustrating a configuration of a stator of a linear motor according to Embodiment 7.

FIG. 20 is a plan view illustrating a configuration of a stator of a linear motor according to Embodiment 8.

FIG. 21 is a partly broken perspective view illustrating a configuration of a stator of a linear motor according to Embodiment 9.

FIG. 22 is a plan view illustrating a configuration of a stator of a linear motor according to Embodiment 10.

FIG. 23 is a plan view illustrating a configuration of a stator of a linear motor according to Embodiment 11.

### BEST MODE FOR CARRYING OUT THE INVENTION

### Embodiment 1

The present invention is described below in detail with reference to the drawings illustrating the embodiments.

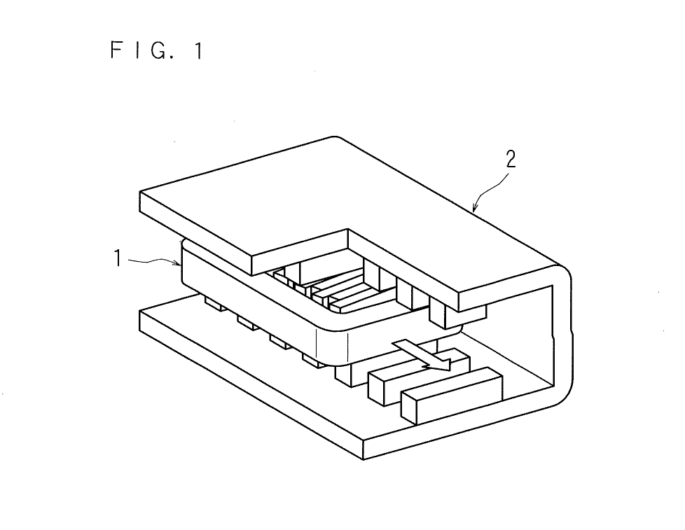

FIG. 1 is a partly broken perspective view illustrating a schematic configuration of a linear motor according to Embodiment 1. The linear motor according to the present embodiment is constructed from a movable element 1 and a stator 2.

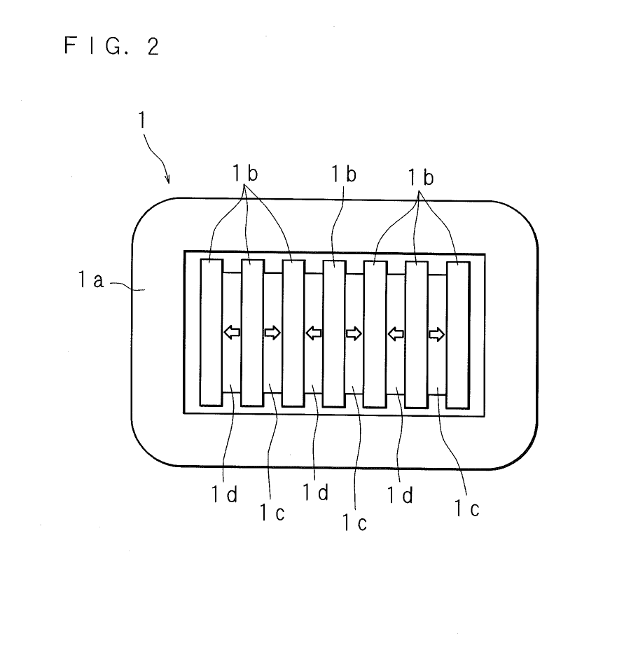

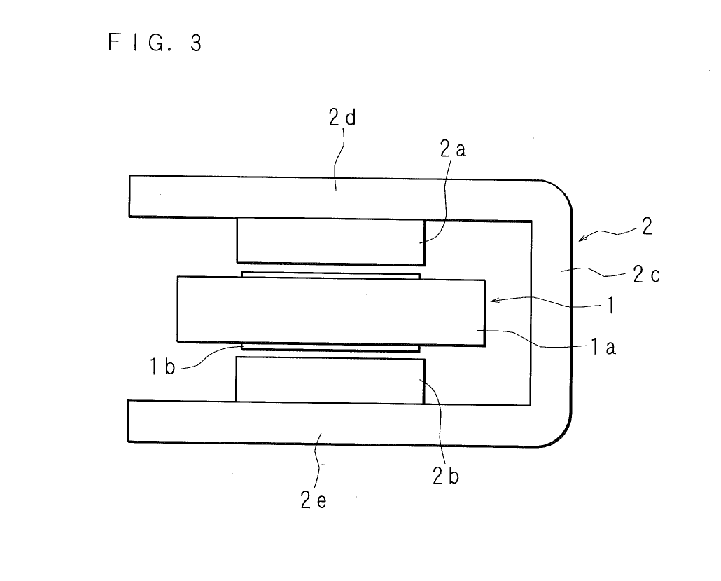

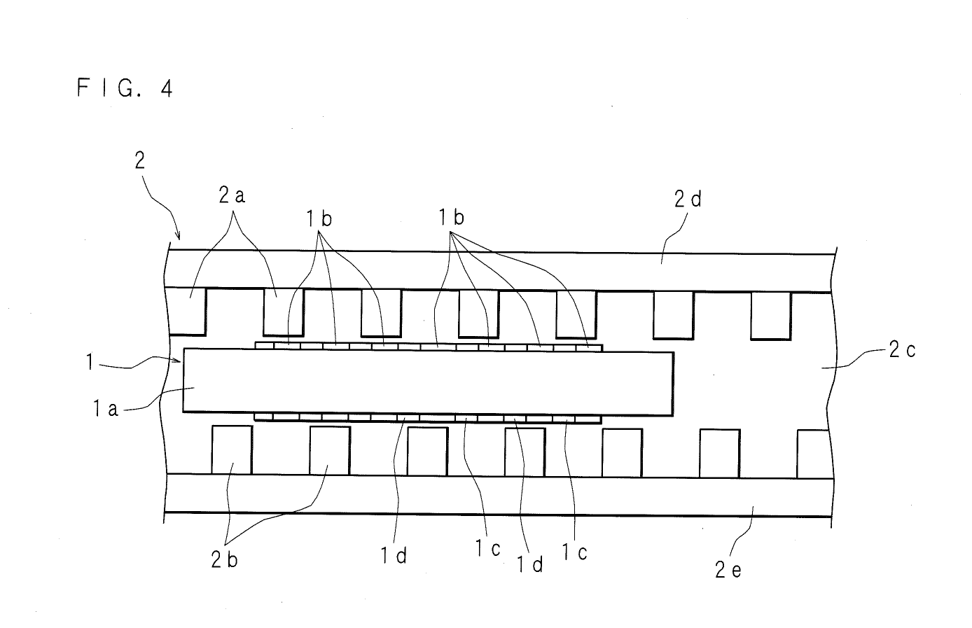

FIG. 2 is a plan view illustrating the movable element 1 of the linear motor according to Embodiment 1. FIG. 3 is a sectional view illustrating a schematic configuration of the linear motor according to Embodiment 1. FIG. 4 is a side view illustrating a schematic configuration of the linear motor according to Embodiment 1.

The movable element 1 is constructed such that an armature core 1b, a permanent magnet 1c, an armature core 1b, a permanent magnet 1d, an armature core 1b, . . . , each having a substantially rectangular parallelepiped shape, are arranged and linked alternately and then a coil 1a is wound around them. As illustrated in FIG. 2, as for the lengths along the linking direction (the thicknesses along the linking direction) of the armature cores 1b and the permanent magnets 1c and 1d, the armature core 1b is formed to be longer (thicker) than the permanent magnets 1c and 1d. Further, as for the length in a direction perpendicular to the linking direction, the armature core 1b is formed to be longer than the permanent magnets 1c and 1d. Further, as for the length in a direction perpendicular to the page of FIG. 2, that is, as for the length in the up and down directions in the page of FIG. 3, the armature core 1b and the permanent magnets 1c and 1d are formed to be almost of the same length, which is longer than the coil 1a. The armature core 1b and the permanent magnet 1c or 1d are linked together such that the faces along the longitudinal direction (a direction perpendicular to the linking direction) are in close contact with each other almost over the entire surfaces.

For example, the armature core 1b may be fabricated by stacking magnetic materials such as silicon steel plates or alternatively fabricated from SMC (Soft Magnetic Composites) obtained by solidifying magnetic metal powder. When such a member is employed, eddy current loss, hysteresis loss, and magnetic deviation in the core material are allowed to be suppressed.

The permanent magnets 1c and 1d are neodymium magnets containing neodymium (Nd), iron (Fe), and boron (B) as main components.

In FIG. 2, open-face arrows attached to the individual permanent magnets 1c and 1d indicate the magnetizing directions of the individual permanent magnets 1c and 1d. Here, the end point of the open-face arrow indicates the N-pole and the start point indicates the S-pole. The permanent magnets 1c and 1d are all magnetized in the linking direction of the armature cores 1b and the permanent magnets 1c and 1d. Then, their directions of magnetization are mutually different and reverse to each other. Then, the armature core 1b is inserted between these permanent magnet 1c and permanent magnet 1d adjacent to each other. Thus, the permanent magnets 1c and 1d adjacent to each other with the armature core 1b in between are magnetized in mutually opposite directions. The coil 1a is wound around the array of the armature cores 1b and the permanent magnets 1c and 1d. That is, the armature cores 1b and the permanent magnets 1c and 1d are arranged in the inside of the coil 1a.

As illustrated in FIG. 3, the stator 2 is constructed from a stator body 2c having a cross section of substantial U-shape, first tooth parts 2a, and second tooth parts 2b. As illustrated in FIG. 1, the stator 2 is elongated in the moving direction of the movable element 1. The first tooth parts 2a and the second tooth parts 2b are arranged on opposite face sides of two opposite plate-shaped parts 2d and 2e of the stator body 2c along the moving direction of the movable element 1. The first tooth part 2a and the second tooth part 2b have a substantially rectangular parallelepiped shape similar to a bar shape. The stator body 2c is formed by bending a magnetic metal such as a rolled steel of flat plate shape. In addition to the bending, the stator body 2c may be formed from flat-plate shaped plates by joining such as welding, with screws, or the like. The opposite plate-shaped parts 2d and 2e of the stator body 2c are magnetically coupled together. The first tooth part 2a and the second tooth part 2b are also formed from magnetic metal plates such as steel plates and then fixed to the stator body 2c by joining such as welding, with screws, or the like.

Alternatively, with leaving each portion corresponding to the tooth part in a magnetic steel plate formed in an substantial U-shape, grooves may be formed by a digging process on both sides of the portion corresponding to the tooth part so that the first tooth part 2a and the second tooth part 2b may be obtained. This permits cost reduction in the stator 2 in comparison with a case that the tooth parts are fixed by joining such as welding, with screws, or the like.

It is preferable that as illustrated in FIGS. 3 and 4, the first tooth part 2a and the second tooth part 2b are in the same shape and of the same dimension as each other. The length in the arranged direction of each of the first tooth part 2a and the second tooth part 2b is set somewhat shorter than the length in the linking direction of the set of the armature core 1b and the permanent magnet 1c or 1d of the movable element 1. The length in the projecting direction of the first tooth part 2a and the second tooth part 2b is set longer than the length in the mounting direction. In the present specification, the length in the projecting direction is longer than the length in the arranged direction, however, may be shorter depending on the arrangement or the dimensions of the stator 2, the first tooth part 2a, the second tooth part 2b, the movable element 1, the armature core 1b, the permanent magnets 1c and 1d, and the coil 1a. The length of the first tooth part 2a and the second tooth part 2b in the right and left directions in the page of FIG. 3 is set somewhat longer than the armature core 1b and the permanent magnet 1c or 1d. In this case, the air gap virtually becomes shorter by virtue of the fringing magnetic flux so that the magnetic flux from the magnet of the movable element is allowed to efficiently flow into the stator 2. When the length is shortened, the movable element is attracted to the center by an attractive force so that a straight moving property is improved.

Alternatively, these lengths may be the same as each other.

Further, the first tooth part 2a and the second tooth part 2b are arranged side by side respectively on the opposite face sides of the two opposite plate-shaped parts 2d and 2e of the stator body 2c at equal intervals. The longitudinal direction of the first tooth part 2a and the second tooth part 2b is arranged approximately at right angles with respect to the moving direction of the movable element 1. The interval of arrangement is somewhat longer than the length in the linking direction of the set of the armature core 1b and the permanent magnet 1c or 1 d of the movable element 1. Further, the first tooth parts 2a and the second tooth parts 2b are arranged alternately (in a staggered arrangement) along the moving direction of the movable element 1 such as not to overlap with each other in the projecting direction.

Here, the first tooth part 2a and the second tooth part 2b may be arranged such that as illustrated in FIG. 4, the faces opposite to the movable element 1 are not opposite to each other. Alternatively, a part of the faces may be opposite to each other. This is because when a part is not opposite to each other, a thrust force is generated in the movable element 1. When the entire surfaces are opposite to each other, no thrust force is generated in the movable element 1.

The above-mentioned movable element 1 is arranged in the stator 2 constructed as described above. As illustrated in FIG. 4, one face of the movable element 1 is opposite to the first tooth part 2a and the other face of the movable element 1 is opposite to the second tooth part 2b. When a first tooth part 2a corresponds to a set of the armature core 1b and the permanent magnet 1c of the movable element 1, the next first tooth part 2a corresponds to a set of the armature core 1b and the permanent magnet 1c. The set of the armature core 1b and the permanent magnet 1d is located between the first tooth part 2a and the first tooth part 2a. Further, the second tooth parts 2b are also arranged at similar intervals apart from a different set of the armature core and the permanent magnet being into correspondence. That is, one first tooth part 2a and one second tooth part 2b are provided in each magnetic cycle. Further, the first tooth part 2a and the second tooth part 2b are provided at positions different from each other by an electrical angle of 180 degrees (positions deviated from each other by ½ magnetic cycle). Thus, a positional relation is realized that, for example, when the first tooth part 2a is opposite to one set of the permanent magnet 1c and the armature core 1b of the movable element 1, the second tooth part 2b is opposite to the other set of the permanent magnet 1d and the armature core 1b of the movable element 1. Here, as described above, it is preferable that the lengths of the armature core 1b and the permanent magnets 1c and 1d in a direction perpendicular to the moving direction of the movable element 1 (in FIG. 2, the lengths of the armature core 1b and the permanent magnets 1c and 1d in a direction perpendicular to the page; and in FIG. 3, the lengths of the armature core 1b and the permanent magnets 1c and 1d in the up and down directions in the page: the lengths of the armature core 1b and the permanent magnets 1c and 1d in the normal direction of the plate surface of the mutually opposite plate-shaped part 2d and plate-shaped part 2e of the stator 2) are approximately the same as each other.

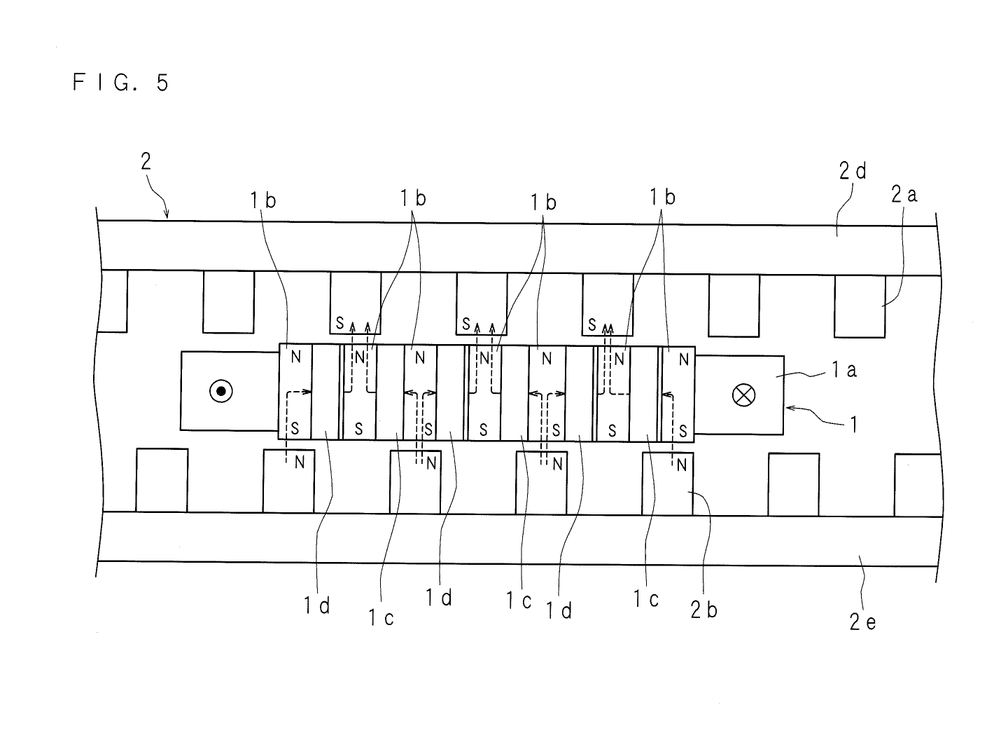

FIGS. 5, 6, and 7 are diagrams for describing the principles of thrust force generation of the linear motor according to Embodiment 1. An alternating current is provided to the coil 1a of the movable element 1. When the coil 1a is energized in the direction indicated in FIG. 5 (a mark with a black dot in the inside of a circle indicates energization from the back side toward the front side of the page and a mark with a cross in the inside of a circle indicates energization from the front side toward the back side of the page), in each armature core 1b, the upper side in the page becomes the N-pole and the lower side in the page becomes the S-pole. As indicated by a dotted-line arrow, a magnetic flux loop is generated such that the magnetic flux generated in each armature core 1b flows into the first tooth part 2a, then passes through the stator body 2c, and then flows from the second tooth part 2b into each armature core 1b. By virtue of the magnetic flux loop, the S-pole is generated in the first tooth part 2a and the N-pole is generated in the second tooth part 2b.

The above-mentioned description has been given for a situation that without taking into consideration the magnetic flux of the magnet, energization is performed so that the first tooth part 2a and the second tooth part 2b on the stator 2 side are magnetized. That is, when the coil wound around the magnetic circuit formed by the permanent magnets 1c and 1d and the armature cores 1b of the movable element 1 is energized, the first tooth part 2a and the second tooth part 2b of the stator 2 are allowed to be magnetized similarly to a case that a coil is wound directly around the first tooth part 2a and the second tooth part 2b of the stator 2.

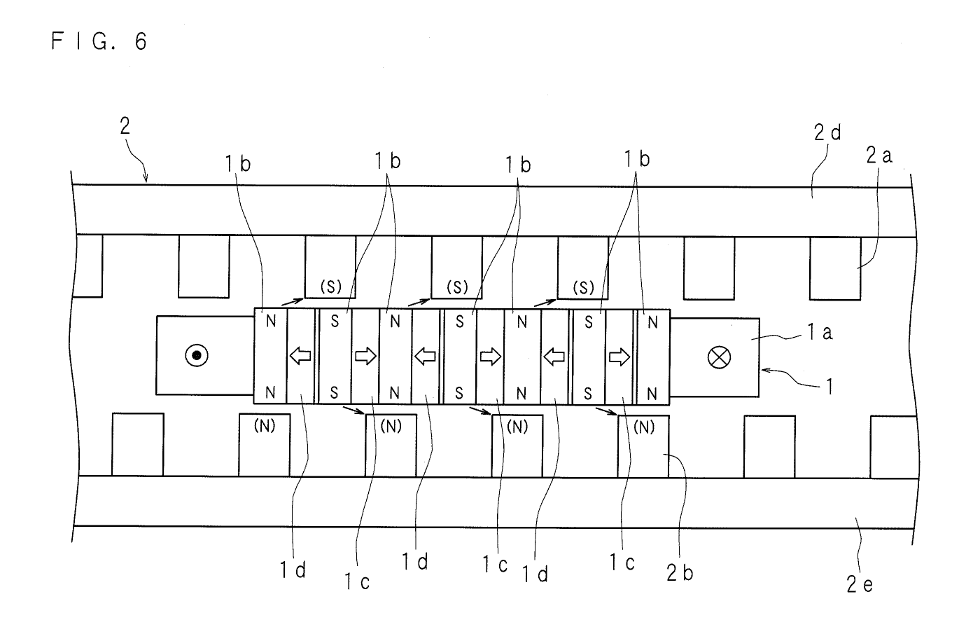

Next, generation of magnetic poles and generation of a thrust force by the permanent magnet are described below with reference to FIG. 6.

When the permanent magnets 1c and 1d are arranged such that the magnetizing directions are opposite to each other relative to the armature core 1b as illustrated in FIG. 6, the entire armature core 1b becomes of monopole. Thus, magnetization is generated such that, for example, the armature core 1b on the leftmost side in the figure becomes the N-pole and the armature core 1b on the second left side becomes the S-pole.

On the other hand, as indicated in the inside of parenthesis in FIG. 6, a magnetic pole magnetized by energization into the winding of the coil 1a is present in the first tooth part 2a and the second tooth part 2b of the stator 2. The magnetic pole on the movable element 1 yoke side (the armature core 1b) generated by the permanent magnets 1c and 1d and the magnetic poles on the first tooth part 2a and the second tooth part 2b sides of the stator 2 magnetized by energization into the winding of the coil 1a attract/repulse each other so that a thrust force is generated in the movable element 1.

Here, magnetization by the permanent magnets 1c and 1d is large and hence a possibility arises that the magnetic pole on the stator 1 side is not distinguishable as the N-pole or the S-pole in actual measurement. This phenomenon occurs ordinarily even in a general permanent magnet synchronous motor and easily explained as the so-called principle of superposition in a magnetic circuit. Even in this case, the same situation holds that magnetization by the coil affects the balance in the magnetic field generated by the permanent magnet so that a thrust force is generated. For the purpose of avoiding misunderstanding, in FIG. 6, magnetic pole symbols for the first tooth part 2a and the second tooth part 2b of the stator 2 are indicated in the inside of parenthesis.

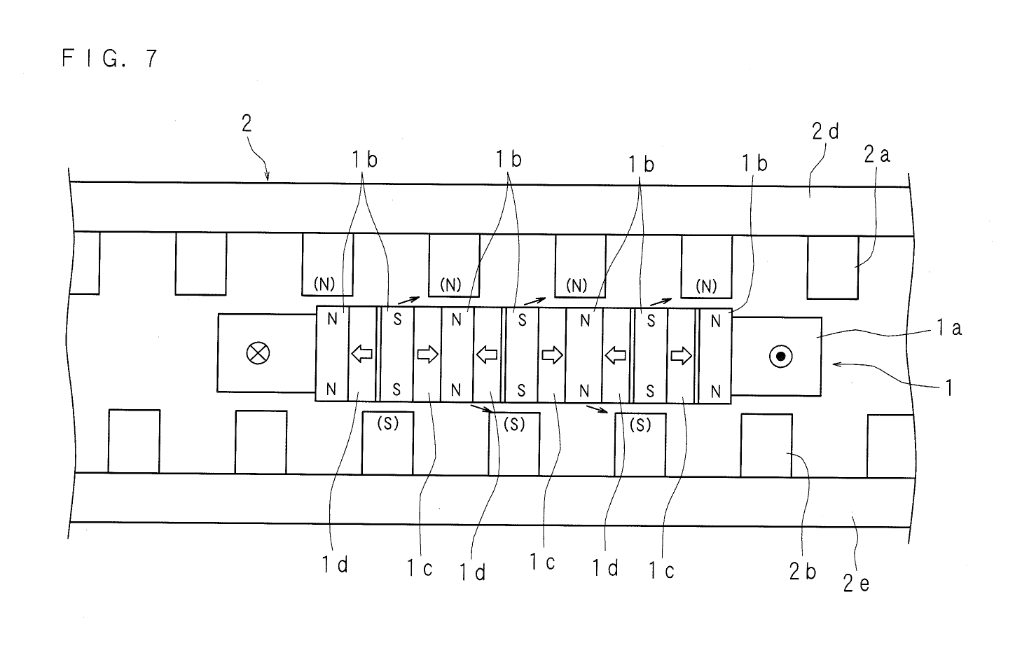

FIG. 7 illustrates a situation that the movable element 1 has moved from the state of FIG. 5 by a distance substantially equal to a set of the armature core 1b and the permanent magnet 1c or 1d, that is, by a distance corresponding to the electrical angle of 180 degrees. In FIG. 7, the direction of the electric current flowing through the coil is reversed. Thus, the N-pole is generated in the first tooth part 2a and the S-pole is generated in the second tooth part 2b. The magnetization of the armature core 1b by the permanent magnets 1c and 1d is not changed. Thus, a magnetic attractive force is generated in the arrow direction illustrated in FIG. 7 and then a the resultant magnetic attractive force in the longitudinal direction (the moving direction) of the movable element 1, which serves as a thrust force so that the movable element 1 moves. When the movable element 1 moves from the state of FIG. 7 by a distance corresponding to the electrical angle of 180 degrees, a state similar to FIG. 5 is realized. When the above-mentioned operation is repeated, the movable element 1 continues moving.

Next, improvement of the influence of an end effect is described below. The end effect indicates that in the linear motor, the magnetic attractive or repulsive force generated at both ends of the movable element affects the thrust force characteristics (cogging characteristics and detent characteristics) of the motor. In the conventional art, for the purpose of reducing the end effect, countermeasures have been taken like the shape of the tooth part at each of both ends is made differed from the other tooth parts. The reason why the end effect is generated is that the magnetic flux loop flows in the same direction as the moving direction (see FIG. 2 in Japanese Patent Application Laid-Open No. 03-139160). However, in the linear motor according to Embodiment 1, the loop (the magnetic flux loop) including a magnetic path passing through the stator body 2c flows in a direction perpendicular to the moving direction. This permits reduction of the influence of the end effect.

As described above, in the linear motor according to Embodiment 1, permanent magnets are employed only in the movable element. Thus, even when the overall length of the linear motor is increased, the quantity of permanent magnets to be employed is not increased and is maintained constant. This permits cost reduction. In addition, the influence of the end effect is allowed to be reduced.

Here, in Embodiment 1, a mode has been illustrated that the movable element 1 is entirely located between the stator 2. However, in the present invention, it is sufficient that the permanent magnets 1c and 1d and the armature cores 1b in the movable element 1 are entirely located between the stator 2. That is, a part of the coil 1a may protrude beyond the stator 2.

Further, the above-mentioned description has been given for a single-phase linear motor (a unit for a single phase). However, employable configurations are not limited to this. For example, when a linear motor of three-phase drive is to be constructed, three movable elements each equivalent to the above-mentioned one may be arranged along a straight line with a gap of tooth part pitch×(n+⅓) or tooth part pitch×(n+⅔) (here, n is an integer). In this case, the integer n may be set up with taking into consideration the length in the longitudinal direction of each movable element.

### Embodiment 2

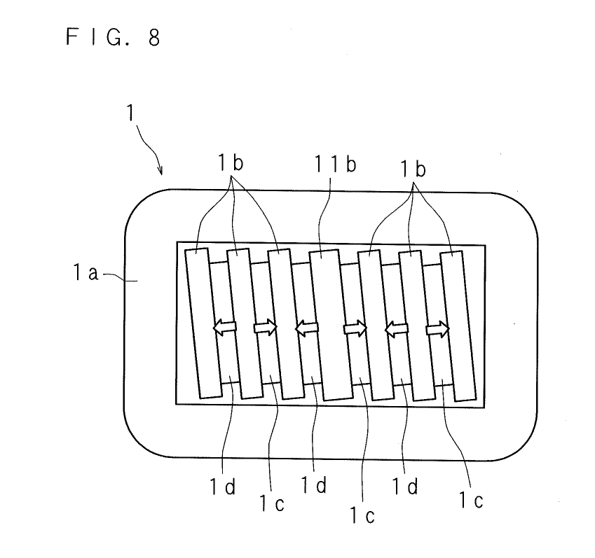

FIG. 8 is a plan view illustrating the movable element 1 of the linear motor according to Embodiment 2. The stator 2 is similar to that of Embodiment 1 and hence is not described here.

In Embodiment 2, in the array of the armature cores 1b and 11b and the permanent magnets 1c and 1d, only the armature core 11b located in the center has a greater length in the linking direction than the other armature cores 1b. Here, at both ends in the longitudinal direction of the armature cores 1b and 11b and the permanent magnets 1c and 1d, the positions in the linking direction (the moving direction) are different from each other. These configurations are employed for reducing the detent force.

When permanent magnets and armature cores are arranged in the movable element, the specific magnetic permeability varies periodically in the moving direction. Thus, higher-order detent force harmonic components become remarkable. In general, in driving of independent phase type, the fundamental wave and the secondary and the fourth harmonic are cancelled out at the time of three phase composition. However, harmonics of order of a multiple of 3, such as the third, the sixth, and the ninth harmonic, are intensified with each other.

A tendency is present that among the harmonic components, especially the sixth harmonic becomes intense. Thus, the length in the moving direction of the armature core 11b is set longer than the other armature cores 1b by τ/6 (τ: polarity pitch, τ=λ/2, and λ: length corresponding to the electrical angle of 360 degrees). By virtue of this, the phases of the detent forces generated in the armature core 1b and the armature core 11b become different by 180 degrees in the sixth harmonic component. Thus, the sixth harmonic component is cancelled out and reduced. Here, in this example, the armature core 11b has been elongated by τ/6. Instead, even when the armature core 11b is made shorter than the other armature cores 1b by τ/6, a similar effect is obtained. That is, it is sufficient to employ an armature core having a different length from the other armature cores by τ/6.

Next, the twelfth and higher harmonic components are allowed to be reduced when the permanent magnets 1c and 1d and the armature cores 1b and 11b are in a skew arrangement. The skew arrangement indicates that the longer sides of the permanent magnets 1c and 1d and the armature cores 1b and 11b are arranged with an inclination (an angle) with respect to a direction perpendicular to the moving direction. That is, both ends in the longitudinal direction of each of the permanent magnets 1c and 1d and the armature cores 1b and 11b have different positions in the moving direction. Here, the angle of skewing (the skew angle) is 0 to 6 degrees or the like.

In the above-mentioned example, the lengths of the armature cores 1b and 11b have been made different from each other and, at the same time, skew arrangement has been employed in the permanent magnets 1c and 1d and the armature cores 1b and 11b. Instead, the length of the armature core 11b may be changed alone without skew arrangement. Further, skew arrangement alone of the permanent magnets 1c and 1d and the armature cores 1b may be employed. Further, when both configurations are adopted, the amount of displacement of the armature core and the skew angle are allowed to be changed independently of each other. Thus, the detent force is allowed to be reduced effectively for a main harmonic component.

As described above, in the linear motor according to Embodiment 2, in addition to the effect obtained by the linear motor according to Embodiment 1, the effect of reducing the harmonic components of the detent force is obtained.

Further, although the armature cores 1b and 11b and the permanent magnets 1c and 1d having been arranged had rectangular parallelepiped shapes, a configuration may be employed that two faces of each of the armature cores 1b and 11b and the permanent magnets 1c and 1d opposite to the inner peripheral surface of the coil 1a are formed in parallel to the inner peripheral surface of the coil 1a. That is, one cross section of each of the armature cores 1b and 11b and the permanent magnets 1c and 1d has a parallelogram shape.

### Embodiment 3

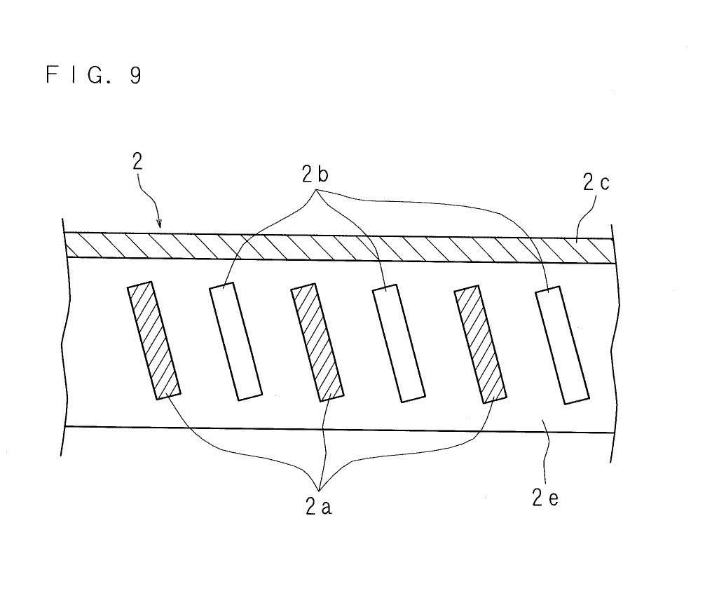

FIG. 9 is a sectional view illustrating the configuration of a stator 2 of a linear motor according to Embodiment 3, which is a transverse cross section of the linear motor taken along the moving direction. The first tooth part 2a and the second tooth part 2b of the stator 2 are in a skew arrangement. The first tooth part 2a and the second tooth part 2b of the stator 2 are arranged such as to be inclined with respect to a direction perpendicular to the moving direction of the movable element. The faces of the first tooth part 2a and the second tooth part 2b facing the moving direction of the movable element (the right and left directions in the page) are inclined about a direction perpendicular to the page (the frontward and backward directions).

The movable element is similar to that of Embodiment 1 given above and hence is not described here. In Embodiment 3, when the first tooth part 2a and the second tooth part 2b of the stator 2 are in a skew arrangement, the detent force is allowed to be reduced even when skew arrangement is not employed in the permanent magnet and the armature core of the movable element.

Here, a movable element similar to that of Embodiment 2 given above may be employed. In this case, it is to be taken into consideration that the angles formed by the longitudinal directions of the tooth part of the stator and the armature core and the permanent magnet of the movable element with respect to a direction perpendicular to the moving direction of the movable element affect reduction of the detent force. That is, sufficient consideration is to be performed on what angles of skewing are to be employed respectively for the tooth part of the stator and the armature core and the permanent magnet of the movable element.

### Embodiment 4

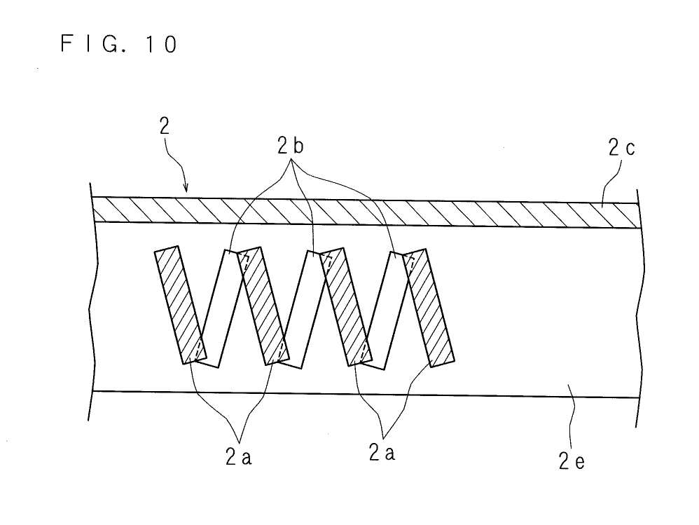

FIG. 10 is a sectional view illustrating the configuration of a stator 2 of a linear motor according to Embodiment 4, which is a transverse cross section of the linear motor taken along the moving direction. The first tooth part 2a and the second tooth part 2b of the stator 2 are in a skew arrangement. That is, the longitudinal direction of the first tooth part 2a and the second tooth part 2b of the stator 2 is arranged such as to be inclined with respect to a direction perpendicular to the moving direction of the movable element. The movable element is similar to that of Embodiment 1 given above and hence is not described here.

As illustrated in FIG. 10, the directions of inclination of the first tooth part 2a and the second tooth part 2b are set reverse to each other. The purpose of this is to suppress a twist caused by the skew arrangement. When the tooth part is in a skew arrangement, the thrust force of the linear motor is generated in a direction inclined by the skew angle with respect to the moving direction and hence, in some cases, the entire movable element is inclined so that a twist is generated. When the directions of inclination of the first tooth part 2a and the second tooth part 2b are set reverse to each other, the thrust force components in a direction (horizontal direction) perpendicular to the moving direction generated by the first tooth part 2a and the second tooth part 2b have reverse directions to each other. Thus, the transverse components of the thrust forces are cancelled out with each other so that the twist is allowed to be avoided.

As described above, in Embodiment 4, in addition to the effect obtained in the linear motor according to Embodiment 1, the following effects are obtained. When the first tooth part 2a and the second tooth part 2b of the stator are in a skew arrangement, the effect of reducing the harmonic components of the detent force is obtained even when skewing is not employed in the armature core and the permanent magnet of the movable element. Further, when the directions of inclination of the first tooth part 2a and the second tooth part 2b are set reverse to each other, the effect of avoiding the twist is obtained.

Here, also in Embodiment 4, similarly to Embodiment 3, the movable element according to Embodiment 2 may be employed. However, sufficient consideration is to be performed on the skew angles in the movable element and the stator.

### Embodiment 5

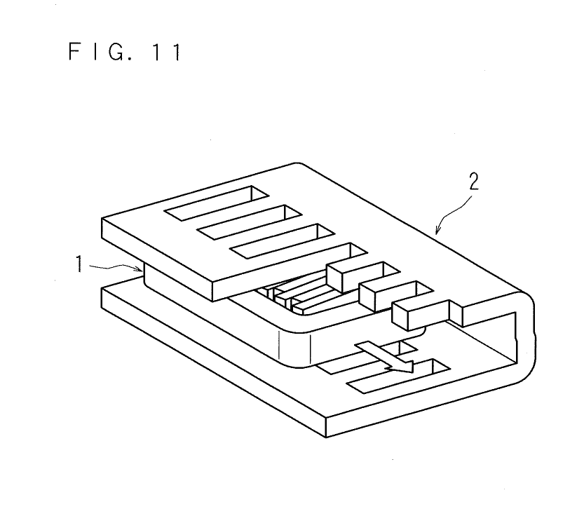

FIG. 11 is a partly broken perspective view illustrating a schematic configuration of a linear motor according to Embodiment 5. The linear motor according to the present embodiment is constructed from a movable element 1 and a stator 2.

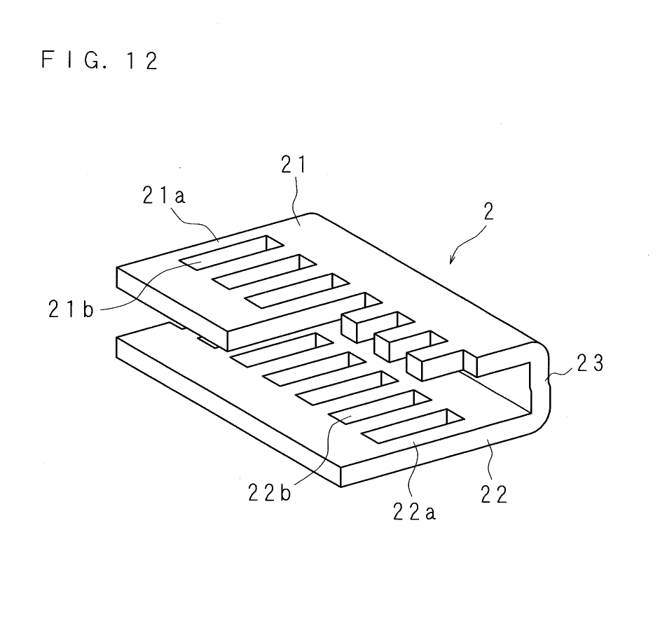

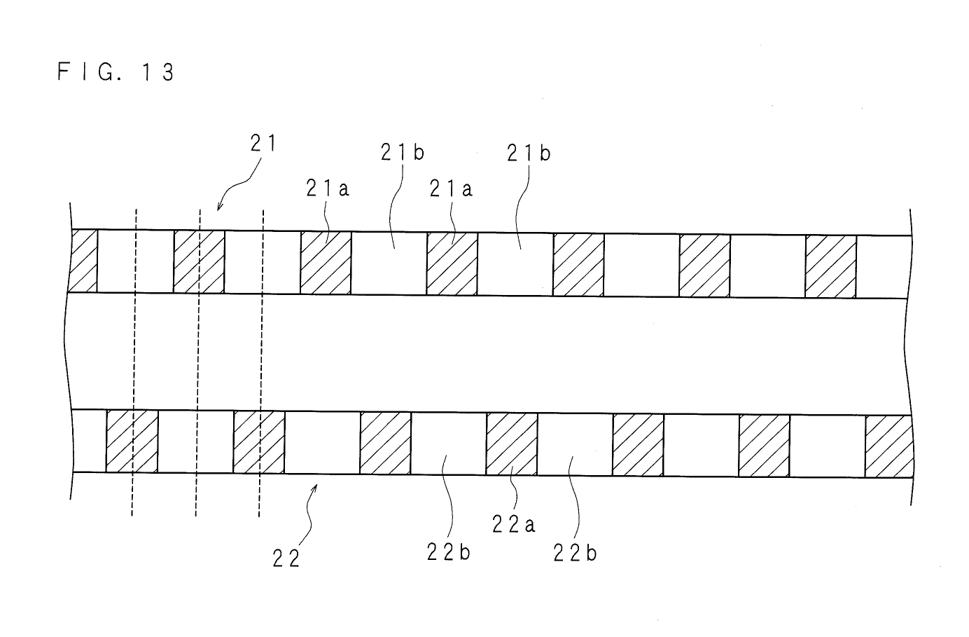

FIG. 2 is a plan view illustrating the movable element 1 of the linear motor according to Embodiment 1. The movable element 1 of the linear motor according to Embodiment 5 is similar to that of Embodiment 1. In the following description, FIG. 2 is referred to. FIG. 12 is a partly broken perspective view illustrating a stator 2 of the linear motor according to Embodiment 5. FIG. 13 is a sectional view illustrating the configuration of a stator 2 of a linear motor according to Embodiment 5.

The movable element 1 is constructed such that an armature core 1b, a permanent magnet (magnet) 1c, an armature core 1b, a permanent magnet (magnet) 1d, an armature core 1b, . . . , each having a substantially rectangular parallelepiped shape, are arranged and linked alternately and then a coil 1a is wound around them. As illustrated in FIG. 2, as for the lengths along the linking direction (the thicknesses along the linking direction) of the armature cores 1b and the permanent magnets 1c and 1d, the armature core 1b is formed to be longer (thicker) than the permanent magnets 1c and 1d. Further, as for the length in a direction perpendicular to the linking direction (the up and down directions in the page), the armature core 1b is formed to be longer than the permanent magnets 1c and 1d. Further, as for the length in a direction perpendicular to the page of FIG. 2, the armature core 1b and the permanent magnets 1c and 1d are set to be almost of the same length, which is longer than the coil 1a. The armature core 1b and the permanent magnet 1c or 1d are linked together such that the faces along the longitudinal direction (a direction perpendicular to the linking direction) are in close contact with each other almost over the entire surfaces.

For example, the armature core 1b may be fabricated by stacking magnetic materials such as silicon steel plates or alternatively fabricated from SMC (Soft Magnetic Composites) obtained by solidifying magnetic metal powder. When such a member is employed, eddy current loss, hysteresis loss, and magnetic deviation in the armature core material are allowed to be suppressed.

The permanent magnets 1c and 1d are neodymium magnets containing neodymium (Nd), iron (Fe), and boron (B) as main components.

In FIG. 2, open-face arrows attached to the individual permanent magnets 1c and 1d indicate the magnetizing directions of the individual permanent magnets 1c and 1d. Here, the end point of the arrow indicates the N-pole and the start point indicates the S-pole. The permanent magnets 1c and 1d are all magnetized in the linking direction of the armature cores 1b and the permanent magnets 1c and 1d. Then, their polarizations of magnetization are different and reverse to each other. Then, the armature core 1b is inserted between these permanent magnet 1c and permanent magnet 1d adjacent to each other. Thus, the permanent magnets 1c and 1d adjacent to each other with the armature core 1b in between are magnetized in opposite directions. The coil 1a is wound around the array of the armature cores 1b and the permanent magnets 1c and 1d. That is, the armature cores 1b and the permanent magnets 1c and 1d are arranged in the inside of the coil 1a.

As illustrated in FIG. 12, the stator 2 has a cross section of substantial horizontal U-shape. As illustrated in FIG. 11, the stator 2 is elongated in the moving direction of the movable element 1. The stator 2 includes: an upper plate part 21 (a plate-shaped part) and a lower plate part 22 (a plate-shaped part) opposite to each other; and a side plate part 23 linking the upper plate part 21 and the lower plate part 22. The side plate part 23 plays the role of magnetically linking the upper plate part 21 and the lower plate part 22. The stator 2 is formed by bending a magnetic metal such as a rolled steel of flat plate shape. Further, each of the upper plate part 21, the lower plate part 22, and the side plate part 23 may be fabricated as a flat-plate shaped magnetic plate and then these plates may be formed by welding or with screws. Here, the stator 2 need not be installed in the orientation illustrated in FIG. 12. Any orientation may be employed as long as being allowed to be installed. Thus, the orientation of installation illustrated in FIG. 12 in which the upper plate part 21 is located on the up side, the lower plate part 22 is located on the down side, and the side plate part 23 is located on the right or left side is not indispensable.

In the upper plate part 21, a plurality of magnetic material parts 21a having a longitudinal direction perpendicular to the moving direction of the movable element 1 are aligned along the moving direction of the movable element 1. The magnetic material parts 21a are aligned with a gap 21b in between. Both ends of the magnetic material part 21a are connected to adjacent magnetic material parts 21a. The gap 21b is a through hole having a rectangular parallelepiped shape provided in a part of the upper plate part 21. The gap 21b is formed by a digging process, a cutting process, a punching process, or the like. The gaps 21b are provided separate from each other along the moving direction of the movable element 1.

The boundary surface between the magnetic material part 21a and the gap 21b is rectangular. The boundary surface is accurately facing to the moving direction of the movable element 1. That is, the surface normal vector of the boundary surface and a vector indicating the moving direction of the movable element are set parallel to each other.

The dimension in the longitudinal direction of the gap 21b is determined such that the dimension in the longitudinal direction of the magnetic material part 21a becomes substantially equal to the dimension in the longitudinal direction of the opposite armature core 1b of the movable element 1. As described above, the magnetic material part 21a and the gap 21b are arranged alternately along the moving direction of the movable element 1. The gaps 21b are formed such that the magnetic material parts 21a are arranged at equal intervals.

The lower plate part 22 has a similar configuration to the upper plate part 21. In the lower plate part 22, a plurality of magnetic material parts 22a having a longitudinal direction perpendicular to the moving direction of the movable element 1 are provided. In the lower plate part 22, two magnetic material parts 22a are separated by a gap 22b.

As illustrated in FIG. 13, the dimension in the moving direction of the movable element 1 of the magnetic material part 21a of the upper plate part 21 (the dimension in the right and left directions in the page) is smaller than the dimension in the moving direction of the movable element 1 of the gap 21b of the upper plate part 21. Similarly, the dimension in the moving direction of the movable element 1 of the magnetic material part 22a of the lower plate part 22 is smaller than the dimension in the moving direction of the movable element 1 of the gap 22b of the lower plate part 22. Further, the dimension in the moving direction of the movable element 1 of the magnetic material part 21a of the upper plate part 21 and the dimension in the moving direction of the movable element 1 of the magnetic material part 22a of the lower plate part 22 are similar to each other. The dimension in the moving direction of the movable element 1 of the gap 21b of the upper plate part 21 and the dimension in the moving direction of the movable element 1 of the gap 22b of the lower plate part 22 are similar to each other.

As illustrated in FIG. 13, in both of the upper plate part 21 and the lower plate part 22, the magnetic material parts 21a and 22a and the gaps 21b and 22b are arranged alternately along the moving direction of the movable element 1. The magnetic material part 21a of the upper plate part 21 and the gap 22b of the lower plate part 22 are set opposite to each other. The gap 21b of the upper plate part 21 and the magnetic material part 22a of the lower plate part 22 are set opposite to each other. In the configuration illustrated in FIG. 13, the dimension in the moving direction of the movable element 1 of each of the magnetic material parts 21a and 22a is smaller than the dimension in the longitudinal direction of the movable element 1 of each of the gaps 21b and 22b. Further, the center positions of the magnetic material part 21a and the gap 22b in the moving direction of the movable element 1 are set to approximately agree with each other. Thus, a part of the gap 21b and a part of the gap 22b are opposite to each other.

In the example illustrated in FIG. 13, the up and down magnetic material parts 21a and 22a are alternate to each other and not overlapped. However, employable configurations are not limited to this. The up and down magnetic material parts 21a and 22a may be overlapped partly. This is because even in such cases, a thrust force is generated. When the up and down magnetic material parts 21a and 22a have the same dimension at the same position in the moving direction of the movable element 1 (the right and left directions in FIG. 13), no thrust force is generated in the linear motor. However, when even a part is overlapped in plan view owing to positional deviation, different dimensions of the up and down magnetic material parts 21a and 22a, or the like, a thrust force is generated.

The side plate part 23 of the stator 2 links the upper plate part 21 and the lower plate part 22. The side plate part 23 is connected to one of the end faces parallel to the moving direction of the movable element 1 of each of the upper plate part 21 and the lower plate part 22. The other end surfaces of the upper plate part 21 and the lower plate part 22 are not linked and constitute the opening part of the stator 2. The side plate part 23 plays the role of magnetically linking the upper plate part 21 and the lower plate part 22.

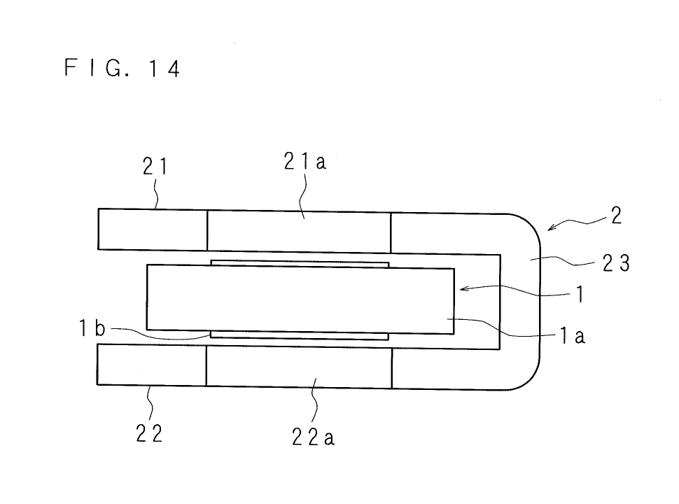

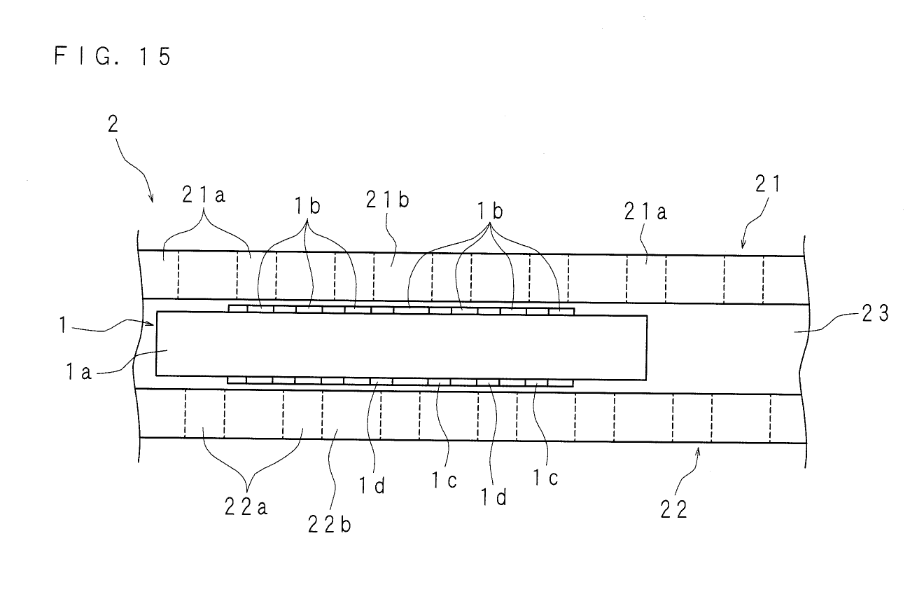

FIG. 14 is a sectional view illustrating a schematic configuration of the linear motor according to Embodiment 5. The frontward and backward directions in the page of FIG. 14 is the moving direction of the movable element 1. FIG. 15 is a side view illustrating a schematic configuration of the linear motor according to Embodiment 5. In FIG. 15, the linear motor is viewed from the opening part side of the stator 2. The right and left directions in the page of FIG. 15 is the moving direction of the movable element 1.

As illustrated in FIG. 14, the stator 2 has a cross section of substantial horizontal U-shape and includes an upper plate part 21 and a lower plate part 22 opposite to each other and a side plate part 23 linking the upper plate part 21 and the lower plate part 22. As illustrated in FIG. 14, the length in the longitudinal direction of the magnetic material parts 21a and 22a (the right and left directions in the page) is set somewhat longer than the length in the longitudinal direction of the armature core 1b and the permanent magnet 1c or 1d. In this case, the air gap virtually becomes shorter by virtue of the fringing magnetic flux so that the magnetic flux from the magnet of the movable element 1 is allowed to efficiently flow into the stator 2. When the length is shortened, the movable element 1 is attracted to the center by an attractive force so that a straight moving property is improved. Alternatively, these lengths may be the same as each other.

As illustrated in FIG. 15, the dimension in the moving direction of the movable element 1 (the right and left directions in the page) of the magnetic material parts 21a and 22a is set somewhat smaller than the dimension in the linking direction of the set of the armature core 1b and the permanent magnet 1c or 1d of the movable element 1. The arrangement interval of the magnetic material parts 21a and 22a, that is, the dimension in the moving direction of the movable element 1 of the gaps 21b and 22b, is set somewhat larger than the dimension in the linking direction of the set of the armature core 1b and the permanent magnet 1c or 1d of the movable element 1.

In FIG. 14 and FIG. 15, the dimension in a direction perpendicular to the moving direction of the movable element 1 of each of the magnetic material parts 21a and 22a, that is, the plate thickness dimension of the upper plate part 21 and the lower plate part 22 (the dimension in the up and down directions in the page of FIG. 14), is set larger than the dimension (the width dimension) in the same direction as the moving direction of the movable element 1 of the magnetic material part. The relation between the two dimensions may be different from the relation illustrated in FIG. 14 depending on the arrangement or the dimensions of the movable element 1, the armature core 1b, the permanent magnets 1c and 1d, the stator 2, the magnetic material parts 21a and 21b, and the coil 1a.

As illustrated in FIG. 15, one face of the movable element 1 is opposite to the magnetic material part 21a and the other face of the movable element 1 is opposite to the magnetic material part 22a. When a magnetic material part 21a corresponds to a set of the armature core 1b and the permanent magnet 1c of the movable element 1, the next magnetic material part 21a corresponds to a set of the armature core 1b and the permanent magnet 1c. Then, a set of the armature core 1b and the permanent magnet 1d is located between the two magnetic material parts 21a. Further, the magnetic material parts 22a also have a similar positional relation apart from corresponding to a different set of the armature core 1b and the permanent magnet 1d. That is, one magnetic material part 21a and one magnetic material part 22a are provided in each magnetic cycle of the movable element 1. Further, the magnetic material part 21a and the magnetic material part 22a are provided at positions different from each other by an electrical angle of 180 degrees (positions deviated from each other by ½ magnetic cycle). Thus, a positional relation is realized that, for example, when the magnetic material part 21a is opposite to the set of one permanent magnet 1c and the armature core 1b of the movable element 1, the magnetic material part 22a is opposite to the set of the other permanent magnet 1d and the armature core 1b of the movable element 1.

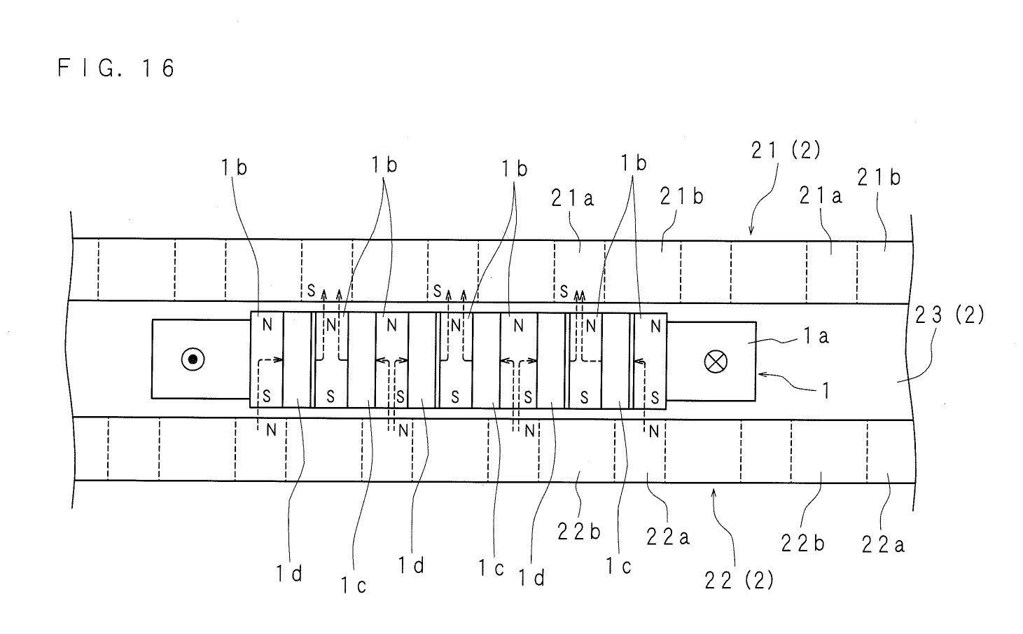

FIGS. 16, 17, and 18 are diagrams for describing the principles of thrust force generation of the linear motor according to Embodiment 5. An alternating current is provided to the coil 1a of the movable element 1. When the coil 1a is energized in the direction indicated in FIG. 16 (a mark with a black dot in the inside of a circle indicates energization from the back side toward the front side of the page and a mark with a cross in the inside of a circle indicates energization from the front side toward the back side of the page), in each armature core 1b, the upper side in the page becomes the N-pole and the lower side in the page becomes the S-pole. As indicated by a dotted-line arrow, a magnetic flux loop is generated such that the magnetic flux generated in each armature core 1b flows into the magnetic material part 21a of the upper plate part 21, then passes through the side plate part 23, and then flows from the magnetic material part 22a of the lower plate part 22 into each armature core 1b. By virtue of the magnetic flux loop, the S-pole is generated in the magnetic material part 21a and the N-pole is generated in the magnetic material part 22a.

The above-mentioned description has been given for a situation that without taking into consideration the magnetization by the magnet, the coil 1a of the movable element 1 is energized so that the magnetic material part 21a and the magnetic material part 22a of the stator 2 are magnetized. That is, when the coil 1a wound around the magnetic circuit formed by the permanent magnets 1c and 1d and the armature cores 1b of the movable element 1 is energized, the magnetic material part 21a and the magnetic material part 22a of the stator 2 are allowed to be magnetized similarly to a case that a coil is wound directly around the magnetic material part 21a and the magnetic material part 22a of the stator 2.

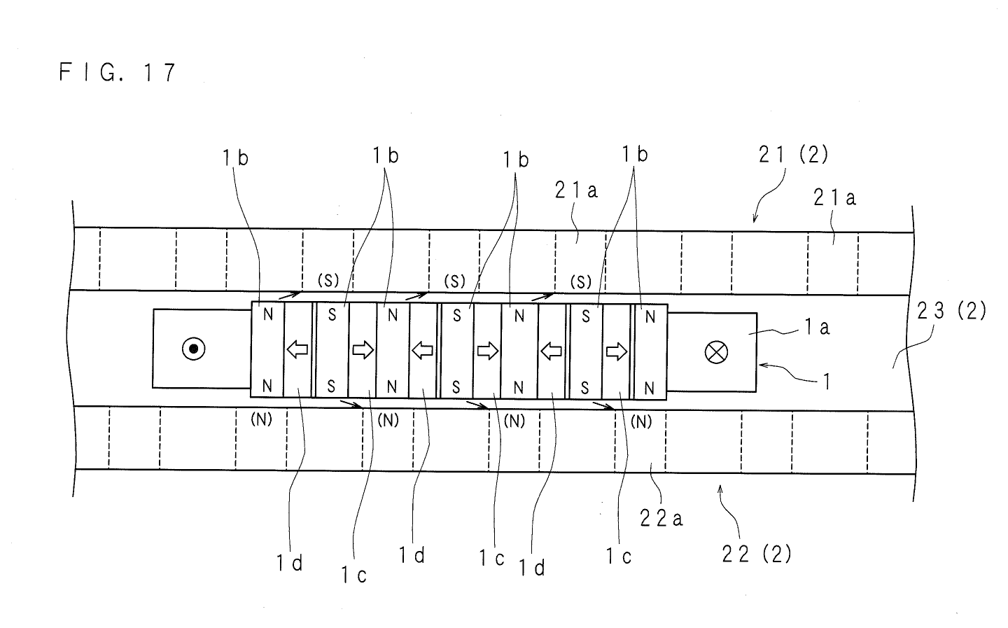

Next, generation of magnetic poles and generation of a thrust force by the permanent magnet are described below with reference to FIG. 17.

When the permanent magnets 1c and 1d are arranged such that the magnetizing directions are opposite to each other relative to the armature core 1b as illustrated in FIG. 17, the entire armature core 1b becomes of monopole. Thus, magnetization is generated such that, for example, the armature core 1b on the leftmost side in the figure becomes the N-pole and the armature core 1b on the second left side becomes the S-pole.

Here, the end point of the open-face arrow indicates the N-pole and the start point indicates the S-pole.

On the other hand, as indicated in the inside of parenthesis in FIG. 17, a magnetic pole magnetized by energization into the winding of the coil 1a is present in the magnetic material part 21a and the magnetic material part 22a of the stator 2. The magnetic pole on the movable element 1 yoke side (the armature core 1b) generated by the permanent magnets 1c and 1d and the magnetic poles on the magnetic material part 21a and the magnetic material part 22a sides magnetized by energization into the winding of the coil 1a attract/repulse each other so that a thrust force is generated in the movable element 1.

Here, magnetization by the permanent magnets 1c and 1d is large and hence a possibility arises that the magnetic pole on the stator 2 side is not distinguishable as the N-pole or the S-pole in actual measurement. This phenomenon occurs ordinarily even in a general permanent magnet synchronous motor and easily explained as the so-called principle of superposition in a magnetic circuit. Even in this case, the same situation holds that magnetization by the coil affects the balance in the magnetic field generated by the permanent magnet so that a thrust force is generated. For the purpose of avoiding misunderstanding, in FIG. 17, magnetic pole symbols for the magnetic material part 21a and the magnetic material part 22a of the stator 2 are indicated in the inside of parenthesis.

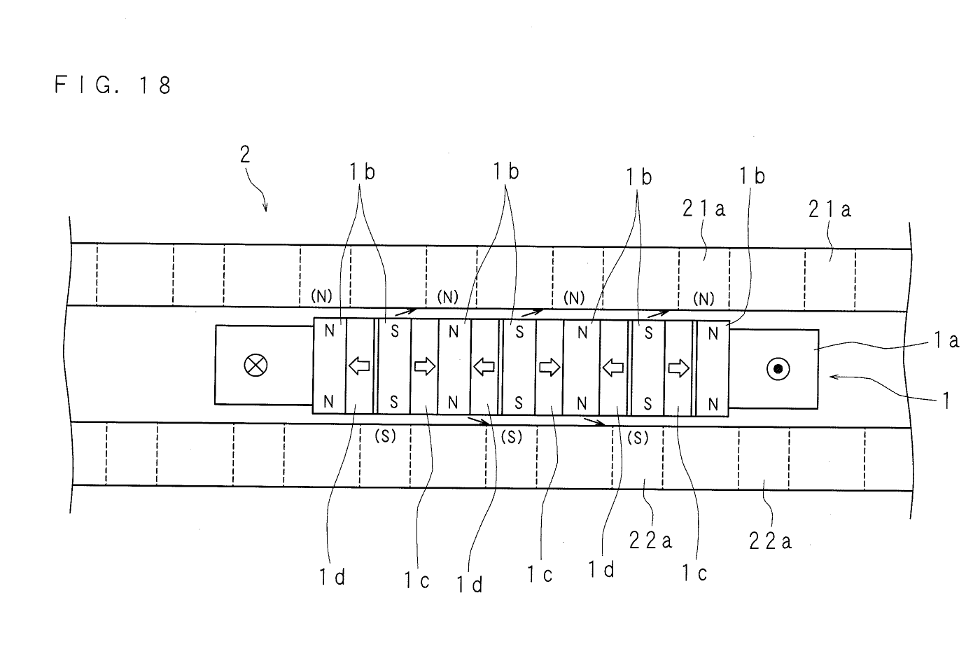

FIG. 18 illustrates a situation that the movable element 1 has moved from the state of FIG. 16 by a distance substantially equal to a set of the armature core 1b and the permanent magnet 1c or 1d, that is, by a distance corresponding to the electrical angle of 180 degrees. In FIG. 18, the direction of the electric current flowing through the coil 1a is reversed. Thus, the N-pole is generated in the magnetic material part 21a and the S-pole is generated in the magnetic material part 22a. The magnetization of the armature core 1b by the permanent magnets 1c and 1d is not changed. Thus, an attractive force is generated in the arrow direction illustrated in FIG. 18 and then a resultant attractive force in the longitudinal direction (the moving direction) of the movable element 1, which serves as a thrust force so that the movable element 1 moves. When the movable element 1 moves from the state of FIG. 18 by a distance corresponding to the electrical angle of 180 degrees, a state similar to FIG. 16 is realized. When the above-mentioned operation is repeated, the movable element 1 continues moving.

Next, improvement of the influence of an end effect is described below. The end effect indicates that in the linear motor, the magnetic attractive or repulsive force generated at both ends of the movable element affects the thrust force characteristics (cogging characteristics and detent characteristics) of the motor. In the conventional art, for the purpose of reducing the end effect, countermeasures have been taken like the shape of the tooth part at each of both ends is made differed from the other tooth parts. The reason why the end effect is generated is that the magnetic flux loop flows in the same direction as the moving direction (see FIG. 2 in Japanese Patent Application Laid-Open No. 03-139160). However, in the linear motor according to Embodiment 5, the loop (the magnetic flux loop) including a magnetic path passing through the side plate part 23 of the stator 2 flows in a direction perpendicular to the moving direction. This permits reduction of the influence of the end effect.

As described above, in the linear motor according to Embodiment 5, permanent magnets are employed only in the movable element 1. Thus, even when the overall length of the linear motor is increased, the quantity of permanent magnets to be employed is not increased and is maintained constant. This permits cost reduction. In addition, the influence of the end effect is allowed to be reduced.

Further, in both of the upper plate part 21 and the lower plate part 22, the magnetic material parts 21a and 22a are respectively separated by the gaps 21b and 22b. The magnetic material parts 21a and 22a are constructed such that a difference in the magnetic resistance is generated respectively relative to the gaps 21b and 22b. In comparison with a case that teeth protruding from one surface of a plate-shaped member are provided like in the conventional art, thickness reduction of the plate-shaped member is allowed so that thickness reduction of the stator 2 is allowed.

Here, in Embodiment 5, a mode has been illustrated that the movable element 1 is entirely located between the stator 2. However, in the present invention, it is sufficient that the permanent magnets 1c and 1d and the armature cores 1b in the movable element 1 are entirely located between the stator 2. That is, a part of the coil 1a may protrude beyond the stator 2.

Further, the above-mentioned description has been given for a single-phase linear motor (a unit for a single phase). However, employable configurations are not limited to this. For example, when a linear motor of three-phase drive is to be constructed, three movable elements each equivalent to the above-mentioned one may be arranged along a straight line with a gap of tooth part pitch×(n+⅓) or tooth part pitch×(n+⅔) (here, n is an integer). In this case, the integer n may be set up with taking into consideration the length in the longitudinal direction of each movable element.

### Embodiment 6

FIG. 8 is a plan view illustrating the movable element 1 of the linear motor according to Embodiment 2. The movable element 1 of Embodiment 2 is employed in the linear motor according to Embodiment 6. The flowing description is given again with reference to FIG. 8. The stator 2 is similar to that of Embodiment 5 and hence is not described here.

In Embodiment 6, as for the movable element 1, as illustrated in FIG. 8, in the array of the armature cores 1b and 11b and the permanent magnets 1c and 1d, only the armature core 11b located in the center has a greater length in the linking direction than the other armature cores 1b. Here, at both ends in the longitudinal direction of the armature cores 1b and 11b and the permanent magnets 1c and 1d, the positions in the linking direction (the moving direction) are different from each other. These configurations are employed for reducing the detent force.

When permanent magnets and armature cores are arranged in the movable element, the specific magnetic permeability varies periodically in the moving direction. Thus, higher-order detent force harmonic components become remarkable. In general, in driving of independent phase type, the fundamental wave and the secondary and the fourth harmonic are cancelled out at the time of three phase composition. However, harmonics of order of a multiple of 3, such as the third, the sixth, and the ninth harmonic, are intensified with each other.

A tendency is present that among the harmonic components, especially the sixth harmonic becomes intense. Thus, the length in the moving direction of the armature core 11b is set longer than the other armature cores 1b by τ/6 (τ: polarity pitch, τ=λ/2, and λ: length corresponding to the electrical angle of 360 degrees). By virtue of this, the phases of the detent forces generated in the armature core 1b and the armature core 11b become different by 180 degrees in the sixth harmonic component. Thus, the sixth harmonic component is cancelled out and reduced. Here, in this example, the armature core 11b has been elongated by τ/6. Instead, even when the armature core 11b is made shorter than the other armature cores 1b by τ/6, a similar effect is obtained. That is, it is sufficient to employ an armature core having a different length from the other armature cores by τ/6.

Next, the twelfth and higher harmonic components are allowed to be reduced when the permanent magnets 1c and 1d and the armature cores 1b and 11b are in a skew arrangement. The skew arrangement indicates that the longer sides of the permanent magnets 1c and 1d and the armature cores 1b and 11b are arranged with an inclination (an angle) with respect to a direction perpendicular to the moving direction. That is, both ends of the faces along the longitudinal direction of each of the permanent magnets 1c and 1d and the armature cores 1b and 11b have different positions in the moving direction. Here, the angle of skewing (the skew angle) is 0 to 6 degrees or the like.

In the above-mentioned example, the lengths of the armature cores 1b and 11b have been made different from each other and, at the same time, skew arrangement has been employed in the permanent magnets 1c and 1d and the armature cores 1b and 11b. Instead, the length of the armature core 11b may be changed alone without skew arrangement. Further, skew arrangement alone of the permanent magnets 1c and 1d and the armature cores 1b may be employed. Further, when both configurations are adopted, the length of the armature core and the skew angle are allowed to be changed independently of each other. Thus, the detent force is allowed to be reduced effectively for a main harmonic component.

As described above, in the linear motor according to Embodiment 6, in addition to the effect obtained by the linear motor according to Embodiment 5, the effect of reducing the harmonic components of the detent force is obtained.

Further, although the armature cores 1b and 11b and the permanent magnets 1c and 1d having been arranged had rectangular parallelepiped shapes, a configuration may be employed that two faces of each of the armature cores 1b and 11b and the permanent magnets 1c and 1d facing the inner peripheral surface of the coil 1a are formed in parallel to the inner peripheral surface of the coil 1a. That is, one cross section of each of the armature cores 1b and 11b and the permanent magnets 1c and 1d has a parallelogram shape.

### Embodiment 7

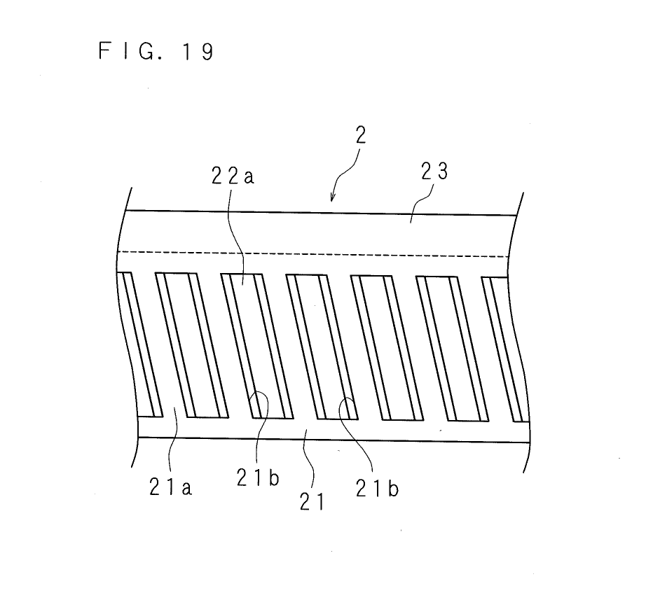

FIG. 19 is a plan view illustrating the configuration of a stator 2 of a linear motor according to Embodiment 7. The magnetic material part 21a of the upper plate part 21 and the magnetic material part 22a of the lower plate part 22 are in a skew arrangement. As illustrated in FIG. 19, the magnetic material part 21a is formed such as to be inclined at a given angle rather than being in parallel to a direction perpendicular to the moving direction of the movable element 1. In association with this, also the gap 21b of the upper plate part 21 is not in parallel to a direction perpendicular to the moving direction of the movable element 1 and is formed such as to be inclined at a given angle. That is, the surface normal vector of the boundary surface between the magnetic material part 21a and the gap 21b is non-parallel to a vector indicating the moving direction of the movable element 1. Further, the plane containing the two vectors is set parallel to the upper plate part 21 and the lower plate part 22.

The gap 21b is a hole provided in the upper plate part 21. Thus, the lower plate part 22 is seen through the gap 21b. As described above, the gap 21b of the upper plate part 21 is in a positional relation of being opposite to the magnetic material part 22a of the lower plate part 22. Thus, what is seen through the hole of gap 21b is the magnetic material part 22a of the lower plate part 22. Further, the magnetic material parts 21a and 22a are smaller than the gaps 21b and 22b. Thus, as illustrated in FIG. 19, a part of the gap 22b of the lower plate part 22 is seen through the gap 21b. The movable element 1 is similar to that of Embodiment 5 given above and hence is not described here.

As described above, in the linear motor according to Embodiment 7, in addition to the effect obtained in the linear motor according to Embodiment 5, the following effects are obtained. In Embodiment 7, when the magnetic material parts 21a and 22a and the gaps 21b and 22b of the stator 2 are in a skew arrangement, the detent force is allowed to be reduced even when skew arrangement is not employed in the permanent magnets 1c and 1d and the armature core 1b of the movable element 1.

Here, a movable element similar to that of Embodiment 6 given above may be employed. In this case, it is to be take into consideration that the angles formed by the longitudinal directions of the magnetic material part and the gap of the stator and the armature core and the permanent magnet of the movable element with respect to a direction perpendicular to the moving direction of the movable element affect reduction of the detent force. That is, sufficient consideration is to be performed on what angles of skewing are to be employed respectively for the magnetic material part and the gap of the stator and the armature core and the permanent magnet of the movable element.

### Embodiment 8

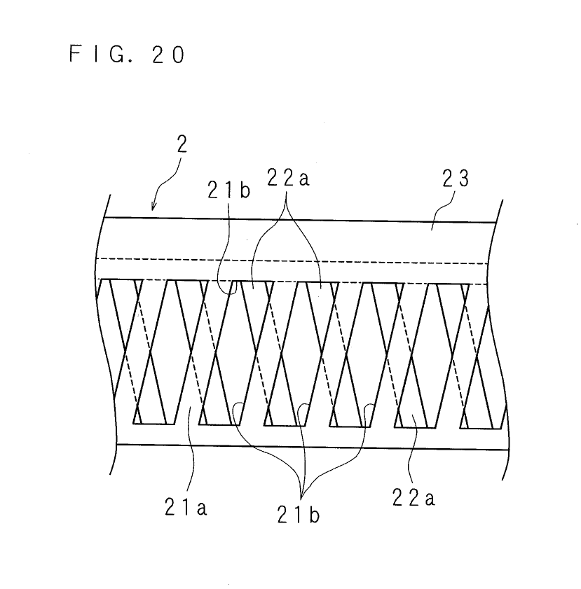

FIG. 20 is a plan view illustrating the configuration of a stator 2 of a linear motor according to Embodiment 8. The magnetic material part 21a of the upper plate part 21 and the magnetic material part 22a of the lower plate part 22 are in a skew arrangement. The movable element 1 is similar to that of Embodiment 5 given above and hence is not described here.

As illustrated in FIG. 20, the directions of inclination of the magnetic material part 21a and the magnetic material part 22a are set reverse to each other. That is, the surface normal vector of the boundary surface between the magnetic material part 21a and the gap 21b is non-parallel to a vector indicating the moving direction of the movable element 1. Further, the surface normal vector of the boundary surface between the magnetic material part 22a and the gap 22b is non-parallel to a vector indicating the moving direction of the movable element 1. Since the directions of inclination of the magnetic material part 21a and the magnetic material part 22a are set reverse to each other, a value obtained by adding an angle formed between a surface normal vector of one of the two plate-shaped parts and the vector indicating the moving direction to an angle formed between a surface normal vector of the other one of the two plate-shaped parts and the vector indicating the moving direction is equal to a value of an angle formed between the surface normal vector of the one of the two plate-shaped parts and the surface normal vector of the other one of the two plate-shaped parts.

The purpose of the configuration that the directions of inclination of the magnetic material part 21a and the magnetic material part 22a are set reverse to each other is to suppress a twist caused by the skew arrangement. When the magnetic material parts 21a and 22a are in a skew arrangement, the thrust force of the linear motor is generated in a direction inclined by the skew angle with respect to the moving direction and hence, in some cases, the entire movable element is inclined so that a twist is generated. When the directions of inclination of the magnetic material part 21a and the magnetic material part 22a are set reverse to each other, the thrust force components in a direction (horizontal direction) perpendicular to the moving direction generated by the magnetic material part 21a and the magnetic material part 22a have reverse directions to each other. Thus, the transverse components of the thrust forces are cancelled out with each other so that the twist is allowed to be avoided.

As described above, in Embodiment 8, in addition to the effect obtained in the linear motor according to Embodiment 5, the following effects are obtained. When the magnetic material part 21a and the magnetic material part 22a of the stator 2 are in a skew arrangement, the effect of reducing the harmonic components of the detent force is obtained even when skewing is not employed in the armature core 1b and the permanent magnets 1c and 1d of the movable element 1. Further, when the directions of inclination of the magnetic material part 21a and the magnetic material part 22a are set reverse to each other, the effect of avoiding the twist is obtained.

Here, also in Embodiment 8, similarly to Embodiment 7, the movable element 1 according to Embodiment 6 may be employed. However, sufficient consideration is to be performed on the skew angles in the movable element 1 and the stator 2.

### Embodiment 9

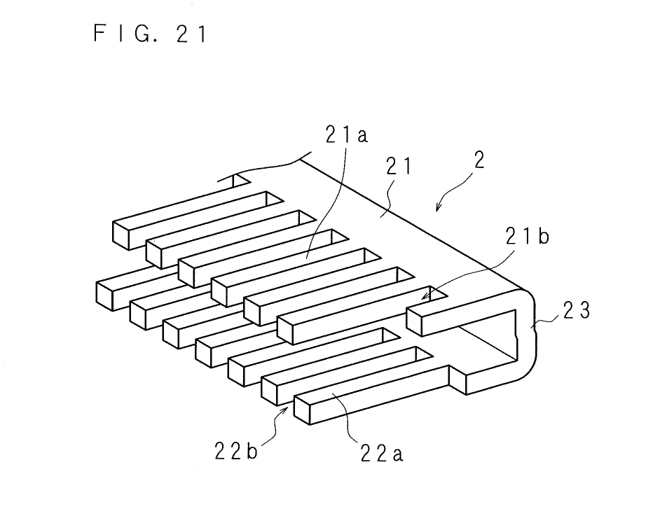

FIG. 21 is a partly broken perspective view illustrating the configuration of a stator 2 of a linear motor according to Embodiment 9. In the stator 2 of Embodiment 5, the gaps 21b and 22b separating the magnetic material parts 21a and 22a have been holes. In contrast, one side alone is opened in Embodiment 9. That is, the opening side of the stator 2 of the gaps 21b and 22b is opened. The magnetic material part 21a is formed in a comb-tooth shape. Similarly, the magnetic material part 22a is formed in a comb-tooth shape. The other points in the configuration including the movable element 1 are similar to those of Embodiment 5.

The magnetic material part 21a formed in the upper plate part 21 has a substantial rectangular parallelepiped shape. The magnetic material part 21a is formed departing by a given distance from the portion linked to the side plate part 23 of the upper plate part 21. The magnetic material part 21a protrudes in a direction perpendicular to the side plate part 23, similarly to the upper plate part 21. The projecting direction of the magnetic material part 21a is adopted as the longitudinal direction. A plurality of magnetic material parts 21a are formed with the gaps 21b in between along the moving direction of the movable element 1.

The shapes of the magnetic material part 22a and the gap 22b formed in the lower plate part 22 are respectively similar to those of the magnetic material part 21a and the gap 21b.

Similarly to Embodiment 5 given above, the positions of the magnetic material part 21a of the upper plate part 21 and the magnetic material part 22a of the lower plate part 22 are deviated in the moving direction of the movable element 1. The positional relation as illustrated in FIG. 13 is employed. The magnetic material part 21a and the gap 22b are opposite to each other and the magnetic material part 22a and the gap 21b are opposite to each other.

As described above, in the linear motor according to Embodiment 9, in addition to the effect obtained in the linear motor according to Embodiment 5, the following effects are obtained. When the upper plate part 21 and the lower plate part 22 of the stator 2 are formed in comb-tooth shapes, the amount of members to be employed in the stator 2 is reduced and hence weight reduction of the stator 2 is allowed. This permits cost reduction.

### Embodiment 10

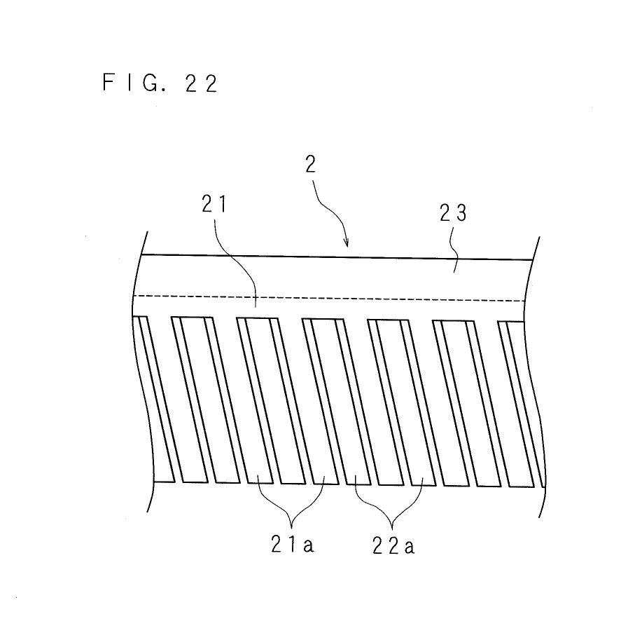

FIG. 22 is a plan view illustrating the configuration of a stator 2 of a linear motor according to Embodiment 10. This configuration is obtained when in the linear motor according to Embodiment 7, the upper plate part 21 and the lower plate part 22 of the stator 2 are made into comb-tooth shapes. Similarly to Embodiment 7, the magnetic material parts 21a and 22a are in a skew arrangement and formed such as to be inclined at a given angle. As illustrated in FIG. 22, the magnetic material part 21a and the magnetic material part 22a are formed such as to be inclined at a given angle rather than being in parallel to a direction perpendicular to the moving direction of the movable element 1.

Since the upper plate part 21 has a comb-tooth shape, the lower plate part 22 is seen through a gap (the gap 21b) between two magnetic material parts 21a. The magnetic material parts 21a provided in the upper plate part 21 and the magnetic material parts 22a provided in the lower plate part 22 are in an alternate positional relation along the moving direction of the movable element 1. Thus, as illustrated in FIG. 22, what is seen through the gap (the gap 21b) between the two magnetic material parts 21a is the magnetic material part 22a provided in the lower plate part 22. The employed movable element 1 is similar to that of Embodiment 5.

As described above, in the linear motor according to Embodiment 10, in addition to the effect obtained in the linear motor according to Embodiment 7, the following effects are obtained. When the upper plate part 21 and the lower plate part 22 of the stator 2 are formed in comb-tooth shapes, the amount of members to be employed in the stator 2 is reduced and hence weight reduction of the stator 2 is allowed. This permits cost reduction.

### Embodiment 11

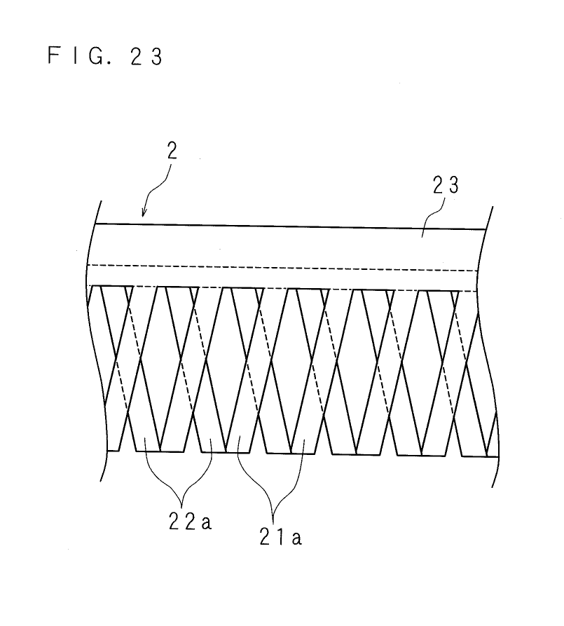

FIG. 23 is a plan view illustrating the configuration of a stator 2 of a linear motor according to Embodiment 11. This configuration is obtained when in the linear motor according to Embodiment 8, the upper plate part 21 and the lower plate part 22 of the stator 2 are made into comb-tooth shapes. The movable element 1 is similar to that of Embodiment 5 given above and hence is not described here.

As illustrated in FIG. 23, similarly to Embodiment 8, the directions of inclination of the magnetic material part 21a and the magnetic material part 22a are set reverse to each other. The purpose of this is to suppress a twist caused by the skew arrangement.

As described above, in the linear motor according to Embodiment 11, in addition to the effect obtained in the linear motor according to Embodiment 8, the following effects are obtained. When the upper plate part 21 and the lower plate part 22 of the stator 2 are formed in comb-tooth shapes, the amount of members to be employed in the stator 2 is reduced and hence weight reduction of the stator 2 is allowed. This permits cost reduction.

In Embodiments 5 to 11, fabrication of the stator 2 may be performed by the following process. Holes serving as the gaps 21b and 22b and comb-tooth shaped tooth parts serving as the magnetic material parts 21a and 22a may be formed in advance by processing (cutting or punching) in a plate composed of magnetic material and then the plate may be bent so that the stator 2 may be formed. As such, formation of the stator 2 is easy and the stator 2 need not be fabricated from a plurality of components. Thus, a linear motor having mechanical stability and a small assembling error is allowed to be fabricated.

In Embodiments 5 to 11, the magnetic material parts 21a and 22a are formed respectively with the gaps 21b and 22b in between. However, employable configurations are not limited to this. Non-magnetic material members (aluminum, copper, or the like) separating the magnetic material parts 21a and 22a may be arranged.

Further, in Embodiments 5 to 11, the magnetic material parts 21a and 22a are respectively parts of the upper plate part 21 and the lower plate part 22 and hence does not protrude beyond the upper plate part 21 and the lower plate part 22. This structure of not protruding may be not exact. A configuration is also included that for the purpose of fine adjustment of the characteristics of the magnetic material parts 21a and 22a, the magnetic material parts 21a and 22a somewhat protrude beyond the other portions of the upper plate part 21 and the lower plate part 22. Further, a configuration is also included that depending on the convenience in processing of the gaps 21b and 22b, the magnetic material parts 21a and 22a protrude beyond the other portions of the upper plate part 21 and the lower plate part 22.

Here, in Embodiments 1 to 11 given above, employable permanent magnets are not limited to a neodymium magnet and may be an alnico magnet, a ferrite magnet, a samarium-cobalt magnet, or the like.

In the present specification, the armature has been employed as a movable element and the plate-shaped parts composed of magnetic material and the tooth parts composed of magnetic material have been employed as a stator. However, the armature disclosed in the present specification may be employed as a stator and the plate-shaped parts and the tooth parts composed of magnetic material may be employed as a movable element.

The technical features (constituent features) described in each embodiment may be combined with each other. Then, such a combination is allowed to form a new technical feature.

Further, it is to be understood that the embodiments given above are illustrative at all points and not restrictive. The scope of the present invention is indicated by the claims and not by the description given above. Further, all changes within the spirit and the scope equivalent to those of the claims are intended to be included.

1-24. (canceled)

25. A linear motor comprising:
a movable element is in a plurality of magnets and armature cores linked alternately along a moving direction are arranged in the inside of a coil and then adjacent magnets with an armature core in between are magnetized in opposite directions;
the stator includes two opposite plate-shaped parts elongated in the moving direction of the movable element and linked magnetically;
in each of opposite faces of the two plate-shaped parts, tooth parts composed of magnetic material having a substantially rectangular parallelepiped shape similar to a bar shape are arranged at given intervals; and
the movable element moves along an arrangement direction of the tooth parts between the two opposite plate-shaped parts.

26. The linear motor according to claim 25, wherein
the tooth parts arranged on one face of the two plate-shaped parts and the tooth parts arranged on the other face of the two plate-shaped parts are arranged alternately along the moving direction of the movable element.

27. The linear motor according to claim 25, wherein
a longitudinal direction of the tooth parts is arranged substantially at right angles to the moving direction of the movable element.

28. The linear motor according to claim 25, wherein
the magnet and the armature core have an substantially rectangular parallelepiped shape similar to a bar shape and respective faces along a longitudinal direction are connected in close contact with each other almost over the entire surfaces.

29. The linear motor according to claim 28, wherein
both ends in the longitudinal direction of each of the magnets and of each of the armature cores have different positions in the moving direction of the movable element.

30. The linear motor according to claim 29, wherein
each of the magnets and each of the armature cores have individually one cross section of a parallelogram shape.

31. The linear motor according to claim 28, wherein
the longitudinal direction of the tooth parts is inclined to a direction perpendicular to the moving direction of the movable element.

32. The linear motor according to claim 31, wherein
the tooth parts arranged on one face of the two plate-shaped parts and the tooth parts arranged on the other face of the two plate-shaped parts are inclined in different directions.

33. The linear motor according to claim 25, including
armature cores having different lengths in the moving direction of the movable element.

34. A linear motor comprising:
a movable element is a plurality of magnets and armature cores linked alternately along a moving direction are arranged inside a coil and then adjacent magnets with the armature core in between are magnetized in opposite directions;
a stator is two mutually opposite plate-shaped parts elongated in the moving direction of the movable element and linked magnetically are included;
the movable element is arranged between the two plate-shaped parts; and
a plurality of magnetic material parts not protruding beyond the plate-shaped parts are aligned side by side along the moving direction in each of the plate-shaped parts.

35. The linear motor according to claim 34, wherein
the plurality of magnetic material parts are aligned side by side with a gap in between at equal intervals.

36. The linear motor according to claim 35, wherein
the gap is a through hole having a rectangular parallelepiped shape and penetrating the plate-shaped part.

37. The linear motor according to claim 35, wherein
the magnetic material part is formed in a comb-tooth shape.

38. The linear motor according to claim 35, wherein
one magnetic material part and the other magnetic material part of the two plate-shaped parts are alternately arranged, at least in part, along the moving direction of the movable element.

39. The linear motor according to claim 35, wherein
a boundary surface between the magnetic material part and the gap is formed to be a planar surface and a surface normal vector with respect to the planar surface is formed to be parallel to a vector indicating the moving direction.

40. The linear motor according to claim 35, wherein:
a boundary surface between the magnetic material part and the gap is formed to be a planar surface and a plane including a surface normal vector with respect to the planar surface and a vector indicating the moving direction is parallel to the plate-shaped part; and
the surface normal vector and the vector indicating the moving direction are non-parallel to each other.

41. The linear motor according to claim 40, wherein
a value obtained by adding an angle formed between a surface normal vector of one of the two plate-shaped parts and the vector indicating the moving direction to an angle formed between a surface normal vector of the other one of the two plate-shaped parts and the vector indicating the moving direction is equal to a value of an angle formed between the surface normal vector of the one of the two plate-shaped parts and the surface normal vector of the other one of the two plate-shaped parts.

42. The linear motor according to claim 34 wherein
the magnet and the armature core have a rectangular parallelepiped shape and respective faces along a longitudinal direction are connected in close contact with each other almost over the entire surfaces.

43. The linear motor according to claim 42, wherein
faces along the longitudinal direction of the magnet and the armature core are facing the moving direction of the movable element and both ends of the faces along the longitudinal direction have different positions in the moving direction such as to be inclined with respect to the moving direction.

44. The linear motor according to claim 34, including
armature cores having different lengths in the moving direction of the movable element.
